(19) United States
(12) Patent Application Publication
(10) Pub. No.: US 2026/0024090 A1
(43) Pub. Date: Jan. 22, 2026

(54) SYSTEMS AND METHODS FOR INSTANT PURCHASING OF DECLINED PAYMENT TRANSACTIONS

(71) Applicant: FlexCorp Inc., Dover, DE (US)

(72) Inventors: Elio VITUCCI, Monaco (MC); Zeev SHOVAL, Tel Aviv (IL)

(73) Assignee: FlexCorp Inc., Dover, DE (US)

(21) Appl. No.: 19/275,732

(22) Filed: Jul. 21, 2025

Related U.S. Application Data
(60) Provisional application No. 63/673,573, filed on Jul. 19, 2024.

(51) Int. Cl. G06Q 20/40

(52) U.S. Cl. CPC G06Q 20/4016; G06Q 20/407

(57) ABSTRACT

Systems and methods for purchasing (typically under a factoring model but other models are still possible), on a selected basis, declined payment transactions; receive, for assessment, the failed payment transaction via API; enrich the data received for the failed transaction with external and internal data; define, via one or more predictive models, the expected cause of payment failure; define, via the one or more predictive models the probability of successfully process in the following days the transactions successfully, calculating the associated cost of risk; interact in real-time with the customer where needed; confirm to the party invoking the service, for each transaction sent for assessment, the purchase or not of the failed payment transaction.

### CROSS-REFERENCE TO RELATED APPLICATION(S)

This application claims priority to U.S. Provisional Patent Application No. 63/673,573, filed Jul. 19, 2024, which is incorporated herein in its entirety.

### FIELD OF THE INVENTION

The present invention generally relates to assessing failed payment transactions in real-time or in a batch manner and accepting the purchase of selected transactions.

### BACKGROUND

Merchants offer their customers the ability to pay for goods and/or services electronically, via credit/debit cards, bank transfers, etc. However, some of these payment transactions fail; when this happens, the merchant cannot complete the sale, and the customer cannot complete the purchase. The failed payment transaction creates an issue for both the merchant and the customer, potentially generating a loss of revenue for the merchant and a bad user experience for the customer.

In existing systems, when a payment transaction fails, merchants typically notify the customer and request an alternative form of payment. This requires the customer to read the message, accept to process the failed payment again, select an alternative form of payment, and accept to provide the details required for the new form of payment, which, when processed, could fail as well. This process is inefficient, creates significant customer friction, and leads to an uncertainty of outcome for both parties. As a result, merchants typically lose most of the sales that experience a failed payment transaction.

There are a few systems available to merchants to tackle failed payment transactions. These mainly consist of immediately re-processing the same transaction via a different payment provider, but these systems lead to poor results as issuers receive again, a few seconds later, the same transaction that they already declined. As a result, almost the totality of the re-processed transactions under this method fail again. Such legacy systems waste substantial processing power unnecessarily (due to the repetitive processing of the same failed payment transactions).

Furthermore, traditional recovery systems suffer from systemic architectural limitations that prevent meaningful improvement in transaction success rates. For example, retries executed within the same merchant account context-often just milliseconds after a decline-trigger issuer-side velocity checks and duplicate suppression logic. These systems cannot distinguish between a fraudulent retry and a legitimate resolution attempt because the payload metadata, payment credentials, and merchant identifiers remain unchanged. As such, the authorization request is treated as a replay of the original, and is frequently auto-declined without substantive re-evaluation. This causes unnecessary strain on payment processors and contributes to diminished approval confidence across merchant portfolios.

Furthermore, these systems typically lack the ability to incorporate new or external data points after the initial decline event. The decision to retry is often made in isolation, without leveraging device fingerprinting, updated behavioral context, fraud intelligence, or enriched consumer information. Without such supplemental inputs, retry decisions rely on static heuristics, resulting in an inability to triage which transactions merit reprocessing and which do not. This one-size-fits-all retry behavior leads to elevated false positives, increased issuer friction, and a higher likelihood of downstream disputes.

Another constraint of legacy platforms is their reliance on a single merchant-of-record framework. Even when a retry logic is executed, the request is submitted under the same merchant account and acquirer, via the same payment processor. This prevents the use of alternate acquirer or processor pathways that might otherwise succeed under different routing conditions.

Finally, existing approaches rarely support real-time or just-in-time customer interaction to resolve missing data or to collect updated credentials. When fallback communication is attempted—such as post-decline emails or SMS reminders—it introduces delays, session abandonment, and asynchronous failure points. These methods are neither scalable nor effective for high-volume transaction environments. Moreover, they are not integrated into the payment decision loop and do not adapt the transaction routing strategy based on customer behavior during the remediation window.

The present innovation takes a different and more sophisticated technical approach, allowing merchants, when experiencing a failed payment transaction from their customers, to invoke a third-party service that, for selected transactions, will offer an instant (or batch depending on the preferred model of the merchant) purchase of that transaction, allowing merchants to complete the sale and customers to complete the purchase despite the failed payment transaction.

There is a technical need for a system and method that can reprocess failed payment transactions through a new merchant-of-record, leveraging real-time data enrichment, probabilistic modeling, adaptive execution routing, and optional customer interaction. Such a solution should operate asynchronously or synchronously, and must function without requiring the originating merchant to directly manage liability, customer re-engagement, or risk assessment logic. The present disclosure addresses these deficiencies.

### SUMMARY

Embodiments of the invention provide methods for accepting the purchase of failed payment transactions. In some embodiments, the invention may include receiving, by a merchant or a third party (hereinafter referred to as a requestor), a request to evaluate a failed payment transaction with the detailed information related to the failed payment transaction; validating the failed payment transaction received via an API; enriching the data received for the failed transaction with external and internal data; define, via one or more predictive models, the expected cause of payment failure; define, via one or more predictive models the probability of successfully process in the following days the transactions successfully, calculating the associated cost of risk; interacting in real-time with the customer where needed; and notifying the party invoking the service of the acceptance or not of the purchaser of the failed payment transaction, and if applicable its related cost.

In some embodiments, validating the request may require authenticating the security token of the requestor; confirming that the requestor has an open and functioning account; and verifying the requestor has not reached any of the assigned limits, such as volume or count limits.

In some embodiments, the requestor may send, via the assigned API, the data related to the failed payment transactions.

In some embodiments, the data sent by the requestor may be complemented or otherwise sent with additional data automatically generated by the widget (e.g., SenseJS) or other application installed on the requestor's website.

In some embodiments, additional data may be acquired via internal and/or external systems to complement the data available to the failed payment transaction. These might include, for example, credit bureaus, fraud detection services, etc.

In some embodiments, additional data may be acquired by processing a new authorization for the failed payment transaction and gathering and comparing the response with the original payment decline reason.

Further embodiments of the invention may include activating the customer user interface, wherein the customer might be requested to provide additional information or perform some actions. Systems according to embodiments of the above methods may be provided.

In some aspects, the techniques described herein relate to a computer-implemented method for reestablishing a declined payment transaction for successful processing, the method including: receiving, by a processor, via an application programming interface (API), transaction data associated with a payment attempt declined during processing by an original merchant, the transaction data including payment credentials, customer identity information, and transaction metadata; validating, by the processor, the received data, wherein validating including authenticating a requestor associated with the original merchant and verifying compliance with at least one of processing thresholds or security requirements; enriching, by the processor, the transaction data with supplemental contextual and behavioral data from one or more sources including one or more of internal databases, third-party data providers, device fingerprinting systems, or embedded client-side activity scripts; analyzing, by the processor, the enriched data using one or more machine learning models configured to evaluate, in real time or near real time, multiple candidate transaction execution paths, the analysis including: identifying a probable cause for the original payment decline; predicting a likelihood of successful reprocessing through each of a plurality of execution paths; selecting a candidate execution path having a success likelihood above a defined threshold; and computing a risk score or cost metric associated with executing the transaction along the selected path; instantiating, based on the analysis, a new transaction under control of a server entity acting as a new merchant of record, wherein the server entity assumes liability and processing responsibility for the reestablished transaction; and transmitting, to the original merchant a transaction outcome message indicating whether the failed payment transaction has been successfully reestablished, declined, or requires further action.

In some aspects, the techniques described herein relate to a method, further including initiating a real-time or near real-time interactive session with a customer device to collect supplemental information or perform authentication actions.

In some aspects, the techniques described herein relate to a method, wherein the candidate execution paths evaluated by the machine learning model include multiple acquiring banks, payment processors, or payment credential variations.

In some aspects, the techniques described herein relate to a method, wherein the machine learning models include at least one of: a classification model for outcome prediction, a regression model for risk scoring, or a reinforcement learning model for dynamic routing optimization.

In some aspects, the techniques described herein relate to a method, wherein the enrichment data includes output from a JavaScript library embedded in the original merchant's website, configured to collect one or more of customer device information, behavioral signals, or session context data.

In some aspects, the techniques described herein relate to a method, wherein the interactive session includes requesting corrected or missing payment information.

In some aspects, the techniques described herein relate to a method, wherein a fingerprinting module generates hashed combinations of customer and transaction data for cross-referencing with historical system-wide behavioral and fraud records.

In some aspects, the techniques described herein relate to a method, wherein a successful reestablishment of the transaction results in a new authorization request initiated by the new merchant of record using the selected transaction path.

In some aspects, the techniques described herein relate to a method, wherein the original merchant does not directly interface with the payment processor once the transaction has been reassigned to the new merchant of record.

In some aspects, the techniques described herein relate to a system for reestablishing a declined payment transaction for successful processing, including: a computer having a processor and a memory; and one or more code sets stored in the memory and executed by the processor, which, when executed, configure the processor to: receive, via an application programming interface (API), transaction data associated with a payment attempt declined during processing by an original merchant, the transaction data including payment credentials, customer identity information, and transaction metadata; validate the received data, wherein validating includes authenticating a requestor associated with the original merchant and verifying compliance with at least one of processing thresholds or security requirements; enrich the transaction data with supplemental contextual and behavioral data from one or more sources including one or more of internal databases, third-party data providers, device fingerprinting systems, or embedded client-side activity scripts; analyze the enriched data using one or more machine learning models configured to evaluate, in real time or near real time, multiple candidate transaction execution paths, the analysis including: identifying a probable cause for the original payment decline; predicting a likelihood of successful reprocessing through each of a plurality of execution paths; selecting a candidate execution path having a success likelihood above a defined threshold; and computing a risk score or cost metric associated with executing the transaction along the selected path; instantiate, based on the analysis, a new transaction under control of a server entity acting as a new merchant of record, wherein the server entity assumes liability and processing responsibility for the reestablished transaction; and transmit to the original merchant a transaction outcome message indicating whether the failed payment transaction has been successfully reestablished, declined, or requires further action.

In some aspects, the techniques described herein relate to a system, further configured to initiate a real-time or near real-time interactive session with a customer device to collect supplemental information or perform authentication actions.

In some aspects, the techniques described herein relate to a system, wherein the candidate execution paths evaluated by the machine learning model include multiple acquiring banks, payment processors, or payment credential variations.

In some aspects, the techniques described herein relate to a system, wherein the machine learning models include at least one of: a classification model for outcome prediction, a regression model for risk scoring, or a reinforcement learning model for dynamic routing optimization.

In some aspects, the techniques described herein relate to a system, wherein the enrichment data includes output from a JavaScript library embedded in the original merchant's website, configured to collect one or more of customer device information, behavioral signals, or session context data.

In some aspects, the techniques described herein relate to a system, wherein the interactive session includes requesting corrected or missing payment information.

In some aspects, the techniques described herein relate to a system, wherein a fingerprinting module generates hashed combinations of customer and transaction data for cross-referencing with historical system-wide behavioral and fraud records.

In some aspects, the techniques described herein relate to a system, wherein a successful reestablishment of the transaction results in a new authorization request initiated by the new merchant of record using the selected transaction path.

In some aspects, the techniques described herein relate to a system, wherein the original merchant does not directly interface with the payment processor once the transaction has been reassigned to the new merchant of record.

In some aspects, the techniques described herein relate to a non-transitory computer-readable medium storing computer-program instructions that, when executed by one or more processors, cause the one or more processors to effectuate operations including: Receiving, via an application programming interface (API), transaction data associated with a payment attempt declined during processing by an original merchant, the transaction data including payment credentials, customer identity information, and transaction metadata; Validating, the received data, wherein validating includes authenticating a requestor associated with the original merchant and verifying compliance with at least one of processing thresholds or security requirements; enriching, the transaction data with supplemental contextual and behavioral data from one or more sources including one or more of internal databases, third-party data providers, device fingerprinting systems, or embedded client-side activity scripts; analyzing the enriched data using one or more machine learning models configured to evaluate, in real time or near real time, multiple candidate transaction execution paths, the analysis including: identifying a probable cause for the original payment decline; predicting a likelihood of successful reprocessing through each of a plurality of execution paths; selecting a candidate execution path having a success likelihood above a defined threshold; and computing a risk score or cost metric associated with executing the transaction along the selected path; instantiating, based on the analysis, a new transaction under control of a server entity acting as a new merchant of record, wherein the server entity assumes liability and processing responsibility for the reestablished transaction; and transmitting, to the original merchant a transaction outcome message indicating whether the failed payment transaction has been successfully reestablished, declined, or requires further action.

In some aspects, the techniques described herein relate to a non-transitory computer-readable medium, wherein the machine learning models include at least one of: a classification model for outcome prediction, a regression model for risk scoring, or a reinforcement learning model for dynamic routing optimization. 600 When a failed payment transaction is sent over by the requestor, the response will be either APPROVED, DECLINED or ACTION REQUIRED. ACTION REQUIRED status is returned when the failed payment transaction could be rescued if some additional/corrected information is provided by the customer—in this example the correct CVV. The customer interaction screen interacts with the customer while the payment is processed. Conversely, current solutions do not support this interaction and are limited to informing customers of the reason for the decline when the payment transaction has already failed.

These and other aspects, features and advantages will be understood with reference to the following description of certain embodiments of the invention.

### BRIEF DESCRIPTION OF THE DRAWINGS

The subject matter regarded as the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous, or similar elements, and in which:

FIG. 1 schematically illustrates the synchronous system interaction with the merchant (Store) for Customer Initiated Transactions (CIT), according to embodiments of the invention;

FIG. 2 schematically illustrates the asynchronous system interaction with the merchant (Store) for Customer Initiated Transactions (CIT), according to embodiments of the invention;

FIG. 3 schematically illustrates the system interaction with the merchant (Store) for Merchant Initiated Transactions (MIT), according to embodiments of the invention;

FIG. 4 is a flowchart of a method for data enrichment of a declined payment transaction, according to at least one embodiment of the invention;

FIG. 5 illustrates an example of logic to define the expected cause of payment failure according to an embodiment of the invention;

FIG. 6 is an example of a customer interaction screen;

FIG. 7 depicts an example computing system with which one or more embodiments may be implemented.

FIG. 8 is a schematic system diagram illustrating components that cooperate to evaluate, enrich, and reprocess declined payment transactions via a new merchant-of-record; and

FIG. 9 is a flow diagram depicting a method for reprocessing a declined payment transaction using data enrichment, predictive modeling, adaptive routing, and optional customer interaction.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention. Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device that manipulates and/or transforms data represented as physical (e.g., electronic) quantities within the computer's registers and/or memories into other data similarly represented as physical quantities within the computer's registers and/or memories or other information transitory or non-transitory or processor-readable storage medium that may store instructions, which when executed by the processor, cause the processor to execute operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items unless otherwise stated. Unless explicitly stated, the method embodiments described herein are not constrained to a particular order or sequence. Additionally, some of the described method embodiments or elements thereof can occur or be performed in a different order from that described, simultaneously, at the same point in time, or concurrently.

Embodiments of the invention provide methods for accepting the purchase of selected failed payment transactions. This may enable merchants to complete a sale and customers to complete a purchase when a payment transaction fails, under an optimized customer user experience. In particular, embodiments of the invention leverage the ability to collect a large set of data, from both internal and external systems, use this data to assess the reasons for which the payment transaction failed, and estimate the cost of risk of each specific failed payment transaction. Unlike prior art solutions, which notify customers of a failed payment transaction and take the customer back to the checkout or equivalent screen, leading to a significant abandonment rate, embodiments of the invention allow to assess in real-time failed payment transactions and to purchase selected transactions with no customer interaction, or with interactive sessions with the customer, while the payment is still being processed. This provides the ability to remove the negative customer experience of a failed payment transaction notification for transactions eligible for purchase, increasing merchant sales and improving customer experience.

Although described in the context of a real-time payment transaction, the same or a similar system may be employed in other contexts where the payment is not processed in real time, and the merchant still benefits from the purchase of selected payment transactions. For example, embodiments of the systems and methods described herein may be employed for subscription payments, for payment methods that do not provide a real-time response, or the like.

Reference will be made to the figures wherein like structures will be provided with like reference designations. The drawings are non-limiting, diagrammatic, and schematic representations of example embodiments, and are not necessarily drawn to scale.

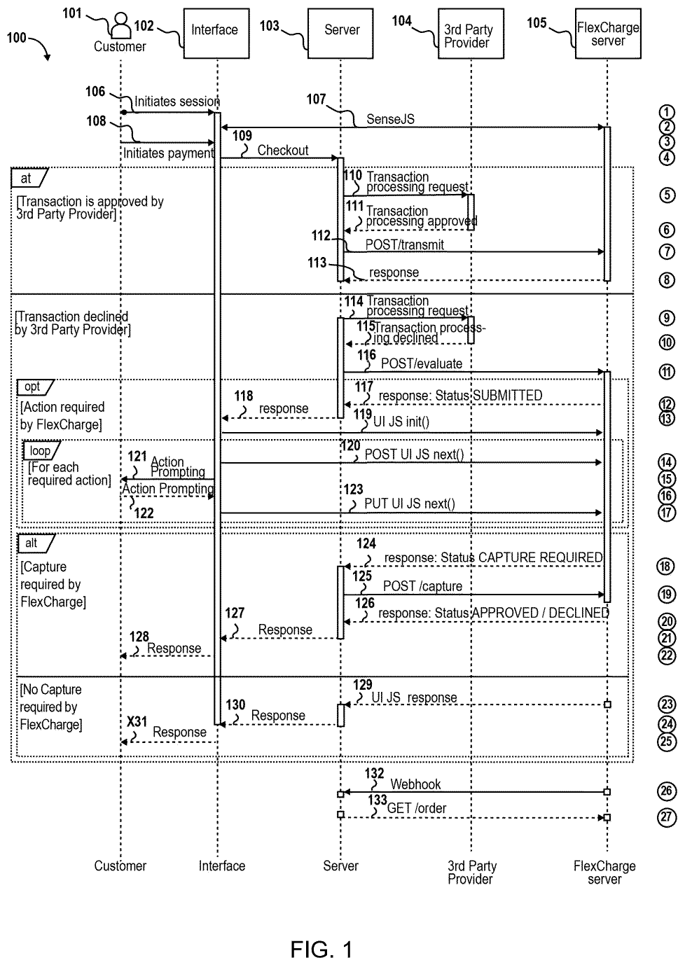

Reference is made to FIG. 1, delineating the intricacies of method 100. This method elucidates the procedural flow and interactions among various actors, including the Customer (101), Interface (102), Server (103), 3rd Party Provider (104), and FlexCharge server (105), within a transactional context relating to a synchronous client-initiated transaction. In various embodiments, the sequence may unfold as follows, detailing the steps from initiation to the definitive status of a transaction:

In some embodiments, the method begins at step 106, when the Customer (101) initiates a session with the Interface (for example, the basket page of the requestor) (102). Then, at step 107, the method may automatically send a data “SenseJS transmission” between the Interface (102) and the FlexCharge server (105). This transmission is enabled by a JavaScript library embedded into the Interface (102); it may play a role in tracking, collecting, recording, and analyzing the interface, and the customer activities. This may include, but is not limited to the customer's Internet Protocol (IP) addresses, device information (brand, model, screen size, screen resolution), Operating System (OS), and browser specifics (location, time zone, version). Following this, in step 108, the Customer (101) may initiate a transaction via the Interface (for example by confirming the purchase and adding payment details on the checkout page of the requestor) (102). Next, at step 109, the Interface (102) may initiate a checkout to the Server (103).

If the transaction is approved by the 3rd Party Provider (104), the method may proceed as follows. In some embodiments, at step 110, the Server (103) may send a transaction processing request to the 3rd Party Provider (104). Next, at step 111, the 3rd Party Provider (104) may respond with a transaction processing approval. Next at step 112, the Server (103) may then send an HTTP request to the/transmit API to the FlexCharge Server (105). Sending the processed transaction at step (111) serves data aggregation and enrichment purposes, aimed at building the required dataset to allow the development of advanced risk models that may intervene in decision making methods, taking into account various data points including, but not limited to, transaction amounts, time zones, device fingerprinting, customer profiles, customer authentication information and payment instruments. Next, at step 113, the FlexCharge Server (105) may respond with a confirmation of the successful receipt of the data back to the Server (103)

Alternatively, in case the transaction processing is declined by the 3rd Party Provider (104), the method may proceed as follows. In step 114, the Server (103) sends a transaction processing request towards the 3rd Party Provider (104). Next, at step 115, the 3rd Party Provider (104) may respond with a transaction processing decline, which might include additional data such as the decline reason code, address and/or CVV march, etc. Next, at step 116, the Server (103) may then send an HTTP request to the/evaluate API to the FlexCharge server (105) for evaluating the transaction's eligibility for FlexCharge services.

Within this alternative path, an optional (OPT) frame may be opened in the case where an action is required by FlexCharge. In some embodiments, at step 117 the FlexCharge Server (105) may respond with Status: ACTION REQUIRED. Next, at step 118, there may be a response from the Server (103) to the Interface (102). Next, at step 119, the Interface (102) may initiate a communication, e.g., a UI JS communication (UI JS init ( ), to the FlexCharge Server (105). UI JS is a JavaScript library that allows customer interaction when some additional actions are required (including but not limited to notification, validation, input, authentication, authorization, prompting for data such as CVV, AVS, Card Expiry Date, Billing Address, etc.). Within this optional frame, a loop (LOOP) frame may be opened for each required action. In some embodiments, in step 120, the Interface (102), may send HTTP requests, e.g., via UI JS next ( ) function, to the FlexCharge Server (105). Next, in step 121, the Interface (102) may send action promptings (for example, asking for the payment method expiry date or asking to confirm their address, etc.) to the Customer (101), then in step 122, the Customer (101) may be performing actions via the Interface (102), and next in step 123, the Interface (102) may be sending HTTP requests via UI JS next ( ) function to the FlexCharge Server (105), concluding the LOOP and the first OPT frame.

In case the merchant we serve requires a deferred capture upon the merchant's confirmation, the system can be configured to request a capture confirmation from the merchant. Within this alternative path, a second alternative (ALT) frame may be initiated. In this case, the method may proceed to step 124, where the FlexCharge Server (105) may respond with status: CAPTURE REQUIRED. Next, at step 125, the Server (103) may send an HTTP request to/capture API to the FlexCharge Server (105). Next, at step 126, the FlexCharge Server (105) may respond toward the Server (103) with status APPROVED or DECLINED. Next at step 127, the Server (103) may forward the response to the Interface (102). Next at step 129, the Interface (102) is responsible to communicate to the Customer the final outcome of the transaction (101). Alternatively, if no capture is required, the method may proceed to step 129, where in some embodiments, the FlexCharge Server (105) may respond toward the Server (103) with status APPROVED or DECLINED. Next at step 130, the Server (103) may forward the response to the Interface (102). Next at step 131, the Interface (102) is responsible to communicate to the Customer the final outcome of the transaction (101). Concluding the second and then the first ALT frames.

Finally, the FlexCharge Server (105) may send a webhook to the Server (103) to update the order status in step 131. Subsequently, the Server (103) may send an HTTP request to the/order API towards the FlexCharge Server (105) to retrieve the order status in step 132.

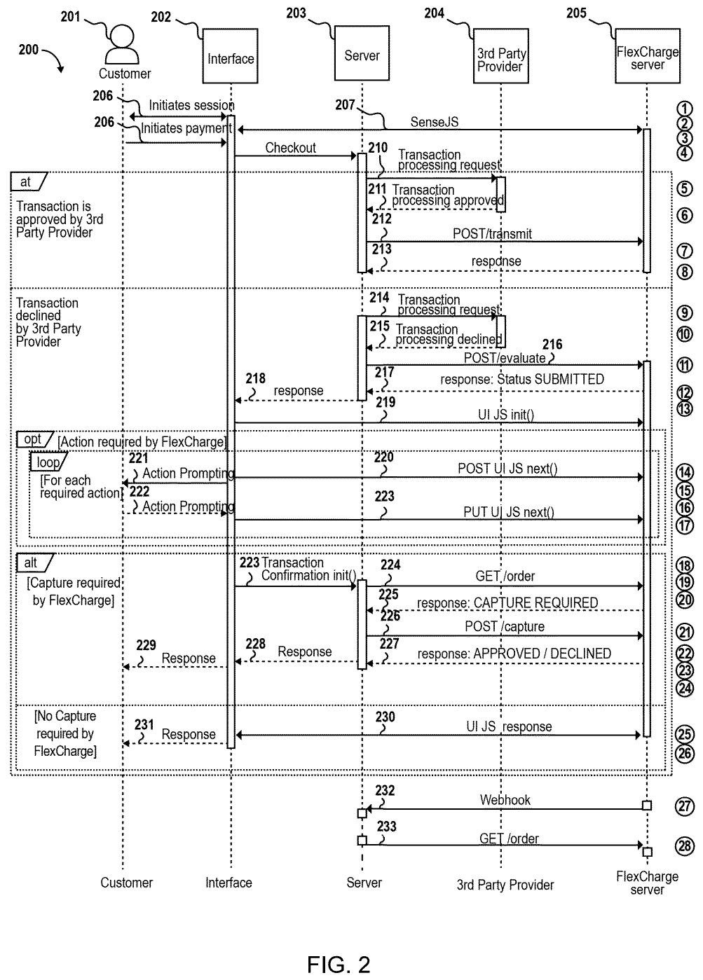

Reference is made to FIG. 2 delineating various embodiments of method 200. This method is similar to method 100 but differs from it in terms of the method of integration with the merchant, allowing an asynchronous response of the service to the merchant. The procedural flow and interactions among various actors, including the Customer (201), Interface (202), Server (203), 3rd Party Provider (204), and FlexCharge server (205), are designed within a transactional context relating to an asynchronous client-initiated transaction. The sequence unfolds as follows, detailing the steps from initiation to the conclusive status of a transaction. The method begins at step 206, where the Customer (201) initiates a session with the Interface (202). Then, at step 207, the method may establish an interaction via SenseJS transmissions between the Interface (202) and FlexCharge server (205). SenseJS is a JavaScript library embedded into the Interface (202), it may play a role in tracking, collecting, recording, and analyzing interface, and customer activities. This may include, but is not limited to, Internet Protocol (IP) addresses, device information (brand, model, screen size, screen resolution), Operating System (OS), and browser specifics (location, time zone, version). Following this, in step 208, the Customer (201) may initiate a transaction via the Interface (202). Next, at step 209, the Interface (202) may initiate a checkout to the Server (203), which includes opening the first Alternative (ALT) frame of this method, based on the outcome of the Transaction Processing.

If the transaction is approved by the 3rd Party Provider (204), the method may proceed as follows. In some embodiments, at step 210, the Server (203) may send a transaction processing request to the 3rd Party Provider (204). Next, at step 211, the 3rd Party Provider (204) may respond with a transaction processing approval. Next at step 212, the Server (203) may then send an HTTP request to the/transmit API to the FlexCharge Server (205). Sending the processed transaction at step (211) may serve data aggregation and enrichment purposes, aimed at building the required dataset to allow the development of advanced risk models that may intervene in decision making methods, taking into account various data points including, but not limited to, transaction amounts, time zones, device fingerprinting, customer profiles, customer authentication information and payment instruments. Next, at step 213, the FlexCharge Server (205) may respond with an identifier key as confirmation towards the Server (203)

Alternatively, in case the transaction processing is declined by the 3rd Party Provider (204), the method may proceed as follows. In step 214, the Server (203) sends a transaction processing request towards the 3rd Party Provider (204). Next at step 215, the 3rd Party Provider (204) may respond with a transaction processing decline. Next at step 216, the Server (203) may then send an HTTP request to the/evaluate API to the FlexCharge server (205) for evaluating the transaction's eligibility for FlexCharge services. Next, at step 217 the FlexCharge Server (205) may respond with a SUBMITTED status. Next, at step 218, there may be a response to the Interface (202). Next at step 219, the Interface (202) may initiate a UI JS communication (UI JS init ( ) to the FlexCharge Server (205). UI JS is a JavaScript library that may allow customer interaction when some additional actions are required (including but not limited to notification, validation, input, authentication, authorization, prompting for CVV, AVS, Card Expiry Date, Billing Address).

Within this alternative path, an option (OPT) frame may be opened in the case where an action is required by FlexCharge. For each required action, in step 220, a loop (LOOP) frame may involve the Interface (202), sending HTTP requests via UI JS next ( ) function to the FlexCharge Server (205). Next, in step 221, the Interface (202) may be sending action promptings to the Customer (201), then in step 222, the Customer (201) may be performing actions via the Interface (202), and next in step 223, the Interface (202) may be sending HTTP requests via UI JS next ( ) function to the FlexCharge Server (205), concluding the OPT frame.

If a Capture is required by FlexCharge, then the method may proceed to step 223, where the Interface (202) may initialize a Transaction Confirmation function (Transaction Confirmation Init ( ) to the Server (203). Next, at step 224, the Server (203) may send an HTTP request to the/order API to the FlexCharge Server (205) in order to receive the latest state of the order. Next at step 225, the FlexCharge Server (205) may respond with the status: CAPTURE REQUIRED. Next, at step 226, the Server (203) may send an HTTP request to/capture API to the FlexCharge Server (205). Next, at step 227, the FlexCharge Server (205) may respond toward the Server (203) with status APPROVED or DECLINED. Next at step 228, the Server (203) may forward the response to the Interface (202). Next at step 229, the Interface (202) is responsible to communicate any scenario the Customer (201). Alternatively, if no capture is required, the method may proceed to step 230. Here, the FlexCharge Server (205) may respond with the definitive status of the order to the Interface (202) via the UI JS. Next at step 231, the Interface (202) is responsible to communicate any scenario the Customer (201).

Finally, the FlexCharge Server (205) may send a webhook towards the Server (203) to update the order status in step 232. Subsequently, the Server (203) may send an HTTP request to the/order API towards the FlexCharge Server (205) to retrieve the order status in step 233.

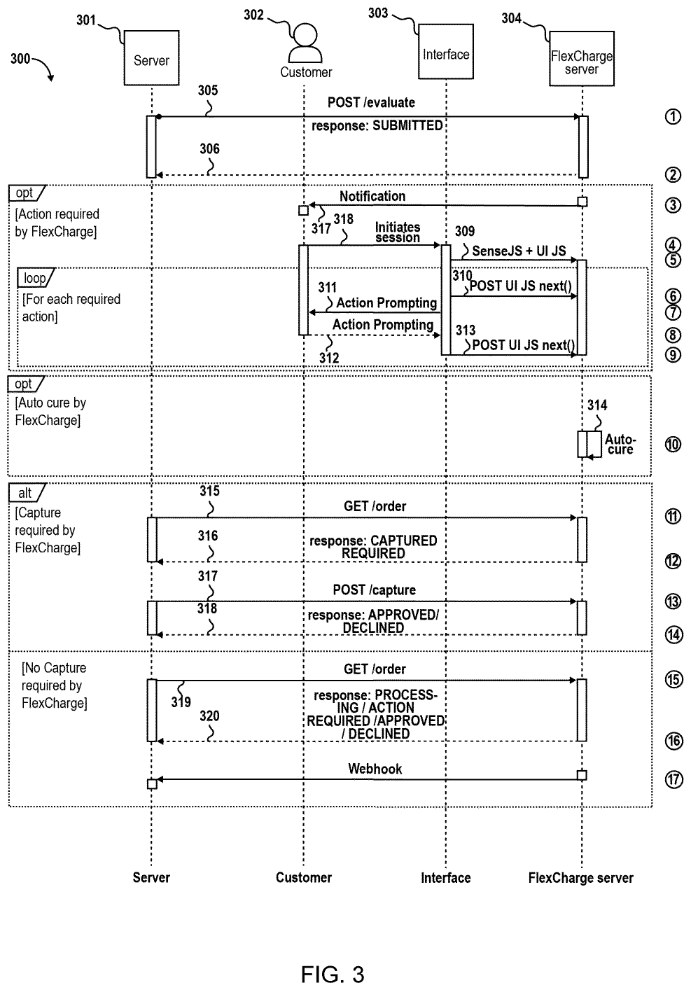

Reference is made to FIG. 3 describing various embodiments of method 300. This method is applicable when customers are not online and is typically used for subscription payments. The method elucidates the procedural flow and interactions among various actors, including the Server (301), Customer (302), Server (303), and FlexCharge server (304), within a transactional context relating to a merchant-initiated transaction. The sequence unfolds as follows, detailing the steps from initiation to the conclusive status of a transaction. The method begins at step 305, where the Server (301) may send an HTTP request to the/evaluate API to the FlexCharge server (304) for evaluating the transaction's eligibility for FlexCharge services. Next, at step 306 the FlexCharge Server (304) may respond with a SUBMITTED status.

In some embodiments, a first option (OPT) frame may be opened in the case where an action is required by FlexCharge. Within that frame, at step 307, FlexCharge Server (304) may send a notification, typically via email but other medias are possible, directly to the Customer (302). This notification may contain a link allowing the Customer (302) to initiate a session with the Interface (303) at step 308. Next, at step 309, the Interface (303) may initiate a SenseJS and UI JS communications to the FlexCharge Server (304). SenseJS is a JavaScript library embedded into the Interface (303), it may play a role in tracking, collecting, recording, and analyzing interface, and customer activities. This may include, but is not limited to, Internet Protocol (IP) addresses, device information (brand, model, screen size, screen resolution), Operating System (OS), and browser specifics (location, time zone, version). UI JS is a JavaScript library that may allow customer interaction when some additional actions are required (including but not limited to notification, validation, input, authentication, authorization, prompting for CVV, AVS, Card Expiry Date, Billing Address). For each required action, in step 310, a loop (LOOP) frame may involve the Interface (303), sending HTTP requests via UI JS next ( ) function to the FlexCharge Server (304). Next, in step 311, the Interface (303) may be sending action promptings to the Customer (302), then in step 312, the Customer (302) may be performing actions via the Interface (303), and next in step 313, the Interface (303) may be sending HTTP requests via UI JS next ( ) function to the FlexCharge Server (304), concluding the first OPT frame.

A second OPT frame may be opened in the case where an Auto-cure process is performed by FlexCharge Server (304). Within that frame, at step 314, the FlexCharge Server (304) may initiate an Auto-cure process, a system function designed to autonomously adapt and execute a set of instructions and parameters to optimize the transaction processing. This set of instructions may include but not limited to: redacting the payload if the FlexCharge Server (304) identifies inaccurate validation information within the transaction payload, for example by adding IP address and/or device information for transactions that were declined for suspected fraud, or providing the correct cardholder address; employing the appropriate processing cadence by determining the optimal frequency at which transactions should be processed, such as defining when to trigger a retry authorization for a transaction that failed for insufficient funds.

Next, an Alternative (ALT) frame may be initiated in the case where a capture is required by FlexCharge. If a Capture is required by FlexCharge, then the method may proceed to step 315, where the Server (301) may send an HTTP request to the/order API to the FlexCharge Server (304) in order to receive the latest state of the order. Next at step 316, the FlexCharge Server (205) may respond with the status: CAPTURE REQUIRED. Next, at step 317, the Server (301) may send an HTTP request to/capture API to the FlexCharge Server (304). Next, at step 318, the FlexCharge Server (304) may respond toward the Server (301) with status APPROVED or DECLINED. Alternatively, if no capture is required, the method may proceed to step 319, where in some embodiments, the Server (301) may send an HTTP request to the/order API to the FlexCharge Server (304) in order to receive the latest state of the order. Next, at step 320, the FlexCharge Server (304) may respond toward the Server (301) with status PROCESSING, ACTION REQUIRED, APPROVED or DECLINED.

Finally, the FlexCharge Server (304) may send a webhook towards the Server (301) to update the order status in step 321.

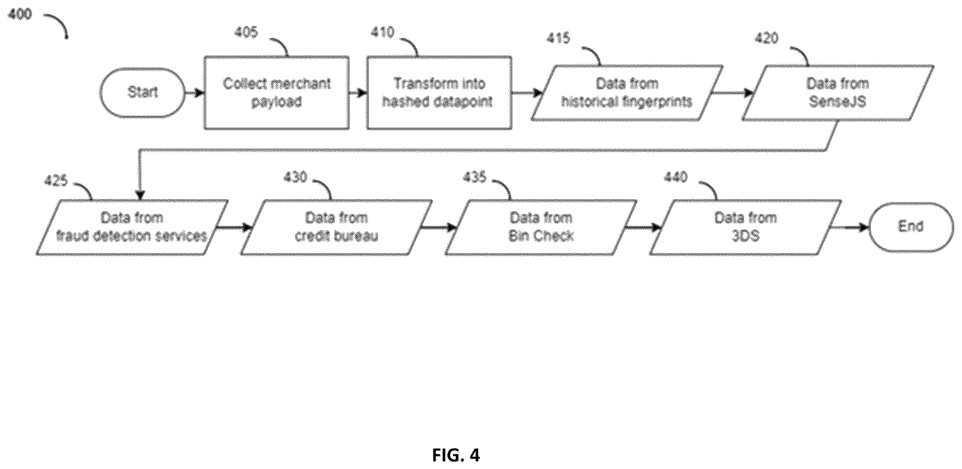

Referring to FIG. 4, a flowchart of one exemplary method 400 of data enriching for failed payment transactions is illustrated, starting from the collection of a Merchant Payload. The embodiments of the invention begin at step 405, when the merchant may be configured to send, via an input system, a processing request of a selected purchase, by sending failed payment transaction payloads to the FlexCharge server. Next, at step 410, the method may transform the payload data points into a hashed combination and aggregate that hashed combination as fingerprints to be used in the risk models. For example, fingerprints could be created by hashing and combining email and address, card number, name+address, etc. Next, at step 415, the method may add to the payload results of the comparison analysis to historical data via these fingerprints. As an example, predictive information added could be how many times the same email was seen in the last x days at merchant and system level and its decline rate, how many different cards were used for the same name+address in the last x days at merchant and system level, etc. This information is added to the payload and is then used for predictive purposes. At step 420, the method may enrich the payload with data from SenseJS, a JavaScript (JS) library embedded on the merchant's client's side (Checkout Page). SenseJS may track, collect, record and analyze customer activities, comprising Internet Protocol addresses (IP), device information such as brand, model, screen size, screen resolution, Operating System (OS), browser information such as location and time zone. At step 425, the method may enrich payload with data from fraud detection services. Fraud detection services data may comprise, scoring, email verification, phone verification and IP address masking detection. Next, at step 430 the method may enrich the payload with data from the Credit Bureau. Next, at step 435, the method may enrich the payload with data resulting from analysis of Bank Identification Number (BIN), comprising of credit card scheme or network, card type (credit, debit, prepaid), card bank name, card brand, card country. Next, at Step 440, the method may enrich the payload with data from the retrieved, processed and analyzed 3D Secure (3DS) token. The 3DS data may comprise card enrollment in 3DS, transaction authentication status and liability shift.

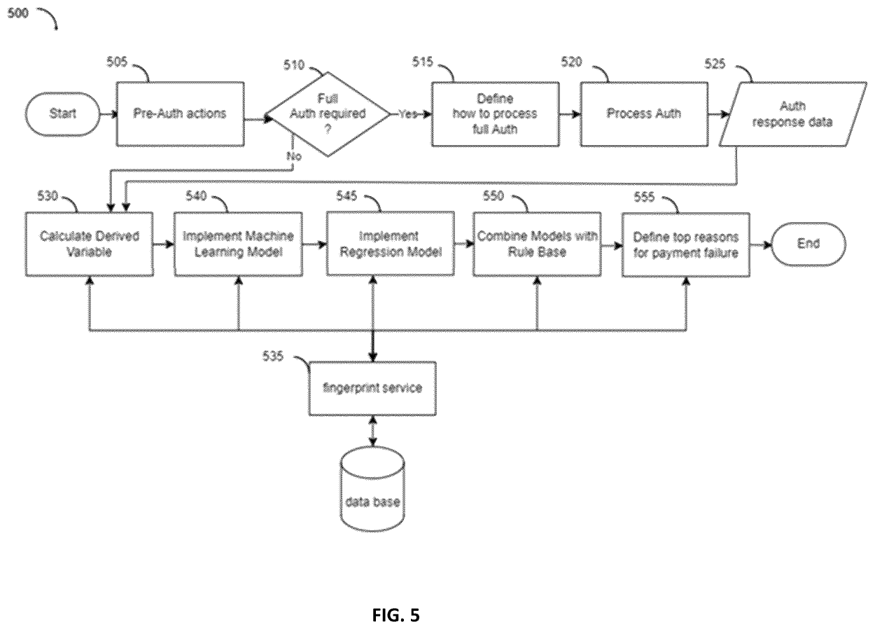

Referring to FIG. 5, a flowchart of one exemplary method 500 of defining expected causes of payment failure for post-auth liability shifts for failed payment transactions is illustrated. The method is initiated at step 505 where the method may perform pre-authorization (pre-Auth) actions for the payment instrument, comprising but not limited to pre-authorization, authorization, full authorization, extra validations including but not limited to card verifications, zero amount verifications, partial amount verifications, standalone AVS checks, network token provisioning. Then, the method may progress to step 510, where an evaluation may be conducted to determine the necessity of a full authorization (Auth) for a given payment instrument. In some embodiments, if a full authorization (Auth) is required, the method may progress to step 515. Here, the method may define the process and where to route the full authorization, based on pre-authorization actions taken at step 505, as well as other conditions defined on eligibility models, machine learning suggestions and the results of methods detailed in FIG. 4. Then at step 520 the method may process the authorization. Next, at step 525, the method may collect data derived from the response of the full authorization request. Upon completion of these tasks, the method may transition to step 530. Alternatively, in some embodiments, if upon the initial evaluation at step 510 the method concludes that no full authorization is required, the method may bypass the intermediate steps and directly proceed to step 530. From here on, the method may proceed to subsequent modelling processes, described in steps 530, 540, 545, 550, 555, as well as, in some embodiments, cross matching data between two or more of these steps, using the Fingerprint Service 535. The Fingerprint Service 535 may cross match the modelling processes data via, including but not limited to, database interrogation, data sets combination, data hashing, sum operations, count operations, check operations and may be used for validation purposes.

At step 530, the method may engage in the calculation of derived variables These are new variables, calculated by combining the payload data with the additional data collected. Examples might be a number of different addresses found at the system level for the same payment card in the last 30 days or the decline rate for the payment card in the last 15 days over the decline rate for the same payment card in the last 90 days. These variables offer additional predictive power compared to the raw data collected. The outputs of 530 may serve as inputs for the subsequent modelling processes; these variables may be enriched by the Fingerprint Service 535 before moving to the next step. Next, at step 540, the method may implement machine learning models. These are predictive classification models that may use the data produced by the Fingerprint Service 535. Next, at step 545, the method may introduce regression models. These models predict the expected reason for decline, but using different data. The regression models may use the data produced by the Fingerprint Service 535. Next, at step 550, the method may use the outputs of the data gathered from previous steps 515, 520, 525, 535, 540, 545, to Rule Based Engine for contributing to determination for the expected reason for decline. This is done by combining the result of the machine learning and regression models and adding as well a series of business rules. Next, at step 555, the method may combine, synthetize the data analysis generated during the previous steps, and instantiate the delineation of N results for most probable reasons for payment failure. For example a transaction might get as the top expected reason of decline a “suspected fraud” due to the customer using a different device from what they usually use for this specific transaction.

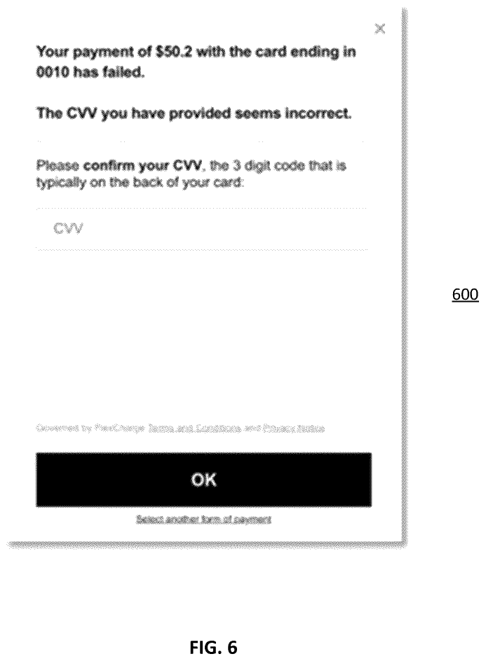

Referring to FIG. 6, an example of user interface 600 that allows a user to interactively request and collect information from a user. When a failed payment transaction is sent over by the requestor, the response will be either APPROVED, DECLINED or ACTION REQUIRED. ACTION REQUIRED status is returned when the failed payment transaction could be rescued if some additional/corrected information is provided by the customer—in this example the correct CVV. The customer interaction screen interacts with the customer while the payment is processed. Conversely, current solutions do not support this interaction and are limited to informing customers of the reason for the decline when the payment transaction has already failed.

Embodiments described in this disclosure may include the use of a special-purpose or general-purpose computer, including various computer software modules, as discussed in greater detail below.

Embodiments within the scope of this disclosure also include computer-readable media, or non-transitory computer storage medium, for carrying or having computer-executable instructions or data structures stored thereon. The instructions, when executed, may cause the processor to carry out embodiments of the invention. Such computer-readable media, or computer storage medium, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). In this description, a “computer” may be any computing system as previously defined herein, or any module or combination of modulates running on a computing system.

Computer database, systems integration, and scheduling technology may be improved by shortening the time taken to assess a failed payment transaction and the associated actions required for that assessment.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

The present disclosure is not to be limited in terms of the particular embodiments described in this application, which are intended as illustrations of various aspects. Many modifications and variations can be made without departing from its scope. Functionally equivalent methods and apparatuses within the scope of the disclosure, in addition to those enumerated, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used in this disclosure is for the purpose of describing particular embodiments only, and is not intended to be limiting.

This disclosure may sometimes illustrate different components contained within, or connected with, different other components. Such depicted architectures are merely exemplary, and many other architectures can be implemented that achieve the same or similar functionality.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes that come within the meaning and range of equivalency of the claims are to be embraced within their scope.

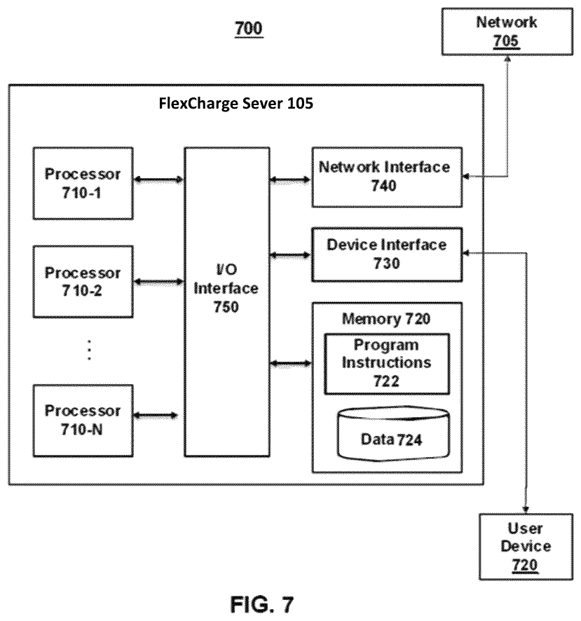

FIG. 7 is a diagram that illustrates an exemplary computing system 700 in accordance with embodiments of the present technique. Various portions of systems and methods described herein, may include or be executed on one or more computing systems similar to computing system 700. Further, processes and modules described herein may be executed by one or more processing systems similar to that of computing system 700. For example, FlexCharge server 105 may execute operations using a processing system that is the same or similar to computing system 700.

Computing system 700 may include one or more processors (e.g., processors 710-1-710-N) coupled to system memory 720, an input/output I/O device interface 730, and a network interface 740 via an input/output (I/O) interface 750. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 700. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 720). Computing system 700 may be a uni-processor system including one processor (e.g., processor 710-1), or a multi-processor system including any number of suitable processors (e.g., 710-1-710-N). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 700 may include a plurality of computing devices (e.g., distributed computing systems) to implement various processing functions.

I/O device interface 730 may provide an interface for connection of one or more I/O devices to computing system 700. I/O devices may include devices that receive input (e.g., from a user) or output information (e.g., to a user), such as user devices 120. I/O devices may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices may be connected to computing system 700 through a wired or wireless connection. I/O devices may be connected to computing system 700 from a remote location. I/O devices located on remote computer system, for example, may be connected to computing system 700 via a network, e.g., network(s) 705, and network interface 740.

Network interface 740 may include a network adapter that provides for connection of computing system 700 to a network. Network interface 740 may facilitate data exchange between computing system 700 and other devices connected to the network. Network interface 740 may support wired or wireless communication. The network, such as for example network(s) 705, may include an electronic communication network, such as the Internet, a local area network (LAN), a wide area network (WAN), a cellular communications network, or the like.

System memory 720 may be configured to store program instructions 722 or data 724. Program instructions 722 may be executable by a processor (e.g., one or more of processors 710-1-710-N) to implement one or more embodiments of the present techniques. Program instructions 722 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. a computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 720 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 720 may include a non-transitory computer readable storage medium that may have program instructions stored thereon that are executable by a computer processor (e.g., one or more of processors 710-1-710-N) to cause the subject matter and the functional operations described herein. A memory (e.g., system memory 720) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 750 may be configured to coordinate I/O traffic between processors 710-1-710-N, system memory 720, network interface 740, I/O devices, and/or other peripheral devices. I/O interface 750 may perform protocol, timing, or other data transformations to convert data signals from one component (e.g., system memory 720) into a format suitable for use by another component (e.g., processors 710-1-710-N). I/O interface 750 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 700 or multiple computing systems 700 configured to host different portions or instances of embodiments. Multiple computing systems 700 may provide for parallel or sequential processing/execution of one or more portions of the techniques described herein.

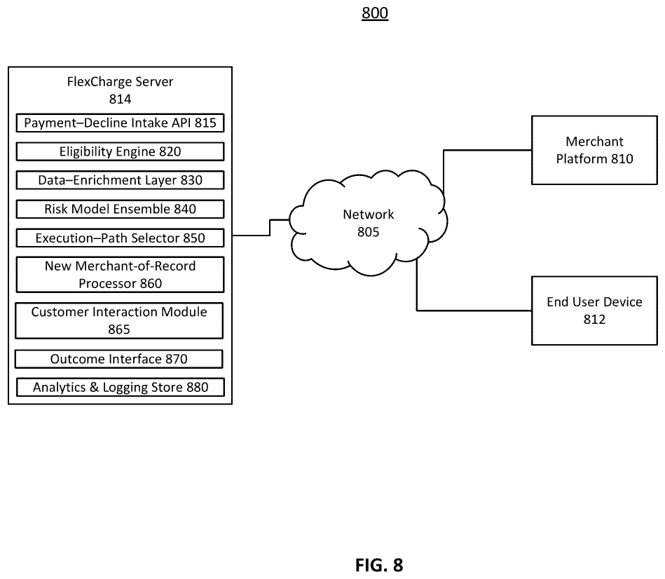

FIG. 8 is a schematic diagram that illustrates an exemplary system architecture 800 in accordance with embodiments of the present invention. Various portions of the systems and methods described herein may be implemented using one or more of the components shown in system 800. Each of the modules illustrated in FIG. 8 may correspond to a distinct logical or physical component within a distributed computing environment, and may operate independently or in coordination across multiple servers, networks, or cloud-hosted services. For example, the FlexCharge server 105, described in earlier figures, may execute one or more of the Payment-Decline Intake API 815, the Risk Model Ensemble 840, or the New Merchant-of-Record Processor 860, depending on deployment configuration. Further, other components such as the Data-Enrichment Layer 830 and Outcome Interface 870 may be implemented as separate services or co-resident functions depending on performance, scalability, or integration requirements.

In some embodiments, the system includes an architecture designed to orchestrate the intelligent reprocessing of declined payment transactions using enriched data, machine learning predictions, adaptive routing, and modular execution logic. This system may operate across a network 805 and comprise multiple interconnected components that cooperate to assess transaction recovery potential, select appropriate execution paths, and carry out reauthorization under a new merchant identity. Each core module in the architecture is described below.

The system includes a network 805 that provides data connectivity between distributed components of the architecture, including API gateways, enrichment services, model inference engines, and transaction processing nodes. The network 805 may include one or more interconnected communication infrastructures such as the public Internet, private enterprise networks, virtual private clouds (VPCs), or hybrid environments combining on-premises and cloud-hosted components. In some embodiments, the network 805 may be equivalent to or implemented using network 705 described in connection with computing system 700 in FIG. 7. Network 805 enables secure, low-latency data transfer among system components and may support protocols such as HTTPS, gRPC, TLS-encrypted sockets, or message bus architectures.

The system may interface with a merchant platform 810 operated by an e-commerce provider, subscription service, or other transaction originator. The merchant platform 810 may submit transaction data to the Payment-Decline Intake API 815 via network 805 and receive outcome information via the Outcome Interface 870. Although not part of the server, merchant platform 810 interacts programmatically with system components and may optionally integrate client-side modules such as SenseJS or customer-facing components of the Customer Interaction Module 865.

The system may also interact with an end user device 812 associated with the customer or cardholder. The end user device 812 may include a browser-based interface, native mobile application, or embedded checkout component configured to participate in payment entry, remediation prompts, or step-up authentication workflows. The end user device 812 communicates with server-side components, including the Customer Interaction Module 865, via network 805. In some embodiments, the device 812 may render secure hosted interfaces that allow the customer to correct or confirm information needed to complete a reprocessing attempt.

In some embodiments, the server-side portion of system 800 includes a set of modular, distributed components that perform core transaction ingestion, evaluation, enrichment, routing, reauthorization, and reporting functions. These components, which are interconnected via network 805 and operate under the control of one or more backend systems (e.g., FlexCharge server 105), are described in further detail below. Each module may operate independently or in coordination with adjacent modules, and may be implemented as a dedicated service, container, or function depending on deployment context.

In some embodiments, the system includes a server 814 that hosts one or more backend components responsible for transaction ingestion, eligibility validation, data enrichment, predictive modeling, execution path selection, reauthorization, customer interaction, and outcome reporting. Server 814 may be implemented using a modular, distributed architecture and may comprise containerized services, serverless functions, or microservices operating in a cloud or hybrid environment. In some implementations, server 814 may be the same as or similar to the FlexCharge server 105 described elsewhere in this specification. Server 814 communicates with external entities including merchant platform 810 and end user device 812 via network 805, and contains internal components 815 through 880 as further described below.

In various embodiments, the system includes a stateless and horizontally scalable interface referred to as the Payment-Decline Intake API 815, which is configured to receive, via a secure communication channel, transaction metadata corresponding to a previously declined payment attempt. Payment-Decline Intake API 815 serves as the primary ingress point for declined transaction events submitted by merchant platforms, e-commerce gateways, or integrated point-of-sale systems.

The API may support a variety of transport protocols and serialization formats, including but not limited to HTTPS with JSON payloads, gRPC with protocol buffers, or message queue-based submission (e.g., AMQP, Apache Kafka) in high-throughput environments. In some embodiments, Payment-Decline Intake API 815 is exposed as a versioned endpoint (e.g., /v1/evaluate) within a microservices architecture and may be fronted by an API gateway for traffic shaping, schema validation, and authentication enforcement.

Authentication mechanisms may include OAuth 2.0 bearer tokens issued by a centralized authorization server, mutual TLS (mTLS) with X.509 certificates, API key pairs issued per client, or signed JWT assertions. In some embodiments, merchants may be assigned client-specific scopes, roles, or quotas that restrict access to specific API operations or data fields.

The incoming payload may contain, at a minimum, a transaction identifier, merchant identifier, transaction timestamp, currency, amount, partial payment instrument metadata (e.g., BIN, masked PAN, token ID), original acquirer response code, and failure classification (e.g., hard decline, soft decline, timeout). Optional fields may include customer identifiers (e.g., hashed email, phone number), device/session identifiers (e.g., cookie ID, session ID), browser and platform metadata, billing address elements, and indicators of prior remediation attempts.

In certain implementations, Payment-Decline Intake API 815 may support batch submission of declined transactions, either as a file upload (e.g., CSV, JSONL, Avro) or as a multipart HTTP payload. This mode may be used in asynchronous or offline integration contexts, such as post-processing failed payments from a subscription billing run or deferred retries from a reconciliation queue.

For transaction de-duplication and idempotency control, the API may accept a merchant-supplied idempotency_key (unique identifier), which is stored in conjunction with the transaction data and checked on subsequent submissions to prevent redundant processing. In some configurations, the system may enforce per-merchant rate limits, per-IP throttle windows, or burst control thresholds, which may be tuned based on contractual service levels or prior behavior.

Upon successful receipt and validation of a transaction payload, the API may return an HTTP 202 (Accepted) response, along with a unique tracking token (e.g., evaluation_id) that may be used for asynchronous polling, webhook correlation, or traceability within observability pipelines. In alternative embodiments, the API may return a synchronous assessment result (e.g., ELIGIBLE, REJECTED, ERROR) depending on configuration flags, integration mode, or the merchant's preference.

In some implementations, declined transaction payloads received by Payment-Decline Intake API 815 may be enriched in-line with partial model scoring or preprocessing before being passed downstream to subsequent system components. In other cases, the API may act purely as a data ingestion layer, with all transformation deferred to the enrichment and modeling layers.

Audit logs may be generated for each invocation and stored in a write-once, tamper-resistant format, including fields such as timestamp, API route, merchant ID, authentication result, request checksum, and processing latency. These logs may be exposed via a secure merchant console, exported to a cloud storage bucket, or retained internally for compliance and monitoring purposes.

In one embodiment, Payment-Decline Intake API 815 may expose introspection or discovery endpoints (e.g., Swagger/OpenAPI definitions) to facilitate dynamic client integration. In other embodiments, it may support error-correcting flows, such as structured 422 Unprocessable Entity responses with field-level error details and retry hints. Such responses enable merchants to implement self-healing retry logic.

Accordingly, Payment-Decline Intake API 815 serves as a foundational component for enabling robust, secure, and flexible ingestion of declined payment transaction data, suitable for deployment across a wide range of merchant environments, integration models, and failure-handling strategies.

In various embodiments, the system includes an Eligibility Engine 820 that serves as a logical gatekeeper between the initial ingestion of declined transaction data and downstream processing layers such as enrichment and modeling. Eligibility Engine 820 evaluates whether each received transaction falls within the operational, contractual, and risk tolerance boundaries defined for a particular merchant, program, or transaction type. It may be implemented as a stateless service callable via API, or as a dedicated microservice deployed in isolation to support high-volume and low-latency transaction streams.

Upon invocation, Eligibility Engine 820 retrieves configuration metadata associated with the submitting merchant. This metadata may define parameters such as region or currency scope, feature entitlements, maximum daily volume thresholds, per-hour submission caps, and merchant integration tier. The engine validates that the requestor is actively enrolled in a compatible reprocessing program and that the transaction does not exceed any quota, usage, or entitlement limits. These checks may be enforced using sliding windows, real-time counters, or policy registries managed by an administrative dashboard or backend configuration system.

Eligibility Engine 820 performs transaction-level rule evaluation on the payload data submitted by Payment-Decline Intake API 815. The rule evaluation may include absolute and conditional thresholds on fields such as transaction amount, supported currencies, timestamp freshness, original decline reason code, issuer identification number (IIN/BIN), card type (credit, debit, prepaid), or payment method type (network token, vault token, physical card). The engine may reject transactions that fall below a minimum threshold, originate from unsupported issuers, use deprecated integration methods, or exhibit signs of program misuse or rule evasion.

In some embodiments, Eligibility Engine 820 accesses auxiliary data sources or services during evaluation. This may include consulting a policy engine that defines real-time routing eligibility, invoking a fraud risk scorer to determine preliminary trustworthiness, or querying a cache of previously evaluated transactions to prevent rapid resubmission or duplicate processing. For example, if a transaction with a given fingerprint or merchant reference was submitted in the last 60 seconds and failed eligibility, the same payload may be automatically rejected under replay prevention logic.

The eligibility decision process may be defined declaratively using a rules engine that supports nested conditions, regular expressions, allowlists/blocklists, and named configuration profiles. Merchants or operators may define, test, and promote rule sets through a version-controlled interface. In some cases, rule evaluation may be supplemented by pre-enrichment of basic data fields (e.g., card BIN metadata) to enable more informed gating decisions.

If a transaction fails eligibility, Eligibility Engine 820 may generate a structured rejection response that includes an error code, a human-readable explanation, and optionally a retry hint or pointer to merchant documentation. These responses may be surfaced in real-time to the merchant platform 810 or logged in batch for analytics, appeals, and post-mortem root cause analysis.

Eligible transactions are annotated accordingly and forwarded to Data-Enrichment Layer 830. Eligibility Engine 820 may also log evaluation metrics such as processing latency, matched rule IDs, rejection codes, and the final eligibility decision for observability, merchant transparency, and quality assurance. These logs may be used to monitor pass/fail ratios over time, detect rule degradation, or identify systemic mismatches between merchant expectations and platform configuration.

The design of Eligibility Engine 820 enables a flexible, fine-grained, and performant control layer that ensures system 800 processes only those declined transactions that fall within accepted risk parameters and contractual scopes. It plays a critical role in protecting downstream modeling, routing, and authorization resources from saturation, fraud attempts, or configuration errors.

In some embodiments, the system includes a Data-Enrichment Layer 830 that functions as a transformation and augmentation pipeline for supplementing raw transaction data with additional context required for high-fidelity risk modeling and decision-making. Data-Enrichment Layer 830 operates on transactions that have passed eligibility screening by Eligibility Engine 820 and prepares them for downstream predictive evaluation by Risk Model Ensemble 840. The enrichment process may occur synchronously or asynchronously, depending on system configuration and merchant preference, and may incorporate both passive augmentation and real-time querying of external sources.

Data-Enrichment Layer 830 integrates with multiple data streams and provider interfaces. Internally, the system may leverage telemetry collected from merchant-side instrumentation, such as JavaScript libraries embedded within checkout flows, to extract device and session metadata. These signals may include IP address, browser characteristics, operating system version, screen dimensions, time zone offset, and indicators of touch or keyboard activity. Client-side data may be collected and hashed or tokenized prior to transmission and subsequently linked to a transaction using a session identifier, device fingerprint, or transaction correlation token. In some implementations, behavioral context—such as the sequence of user interactions, dwell time, or the presence of anomalous patterns—is also captured and incorporated into the enrichment pipeline.

Externally, Data-Enrichment Layer 830 may query fraud prevention platforms, credit bureaus, identity verification services, and card network data providers. These systems may supply additional signals related to risk, including synthetic identity flags, network-level card usage patterns, and velocity indicators. The system may also obtain metadata describing 3-D Secure (3DS) authentication status, including whether the payment credential was enrolled, whether an authentication attempt was initiated or completed, and whether liability shift conditions are met based on the authentication outcome. These data points may be obtained through API integrations or cached feeds updated on a continuous basis.

In some configurations, the system constructs hashed fingerprints derived from combinations of transaction attributes, such as customer email address, billing ZIP code, IP address, and card BIN. These fingerprints are used to query historical behavioral data across the platform or within merchant-specific scopes. The results of such queries may reveal patterns including prior transaction volumes, success and decline ratios, device re-use frequency, and deviations from typical geographic usage. These context signals are converted into structured data and appended to the transaction payload.

The Data-Enrichment Layer 830 may also compute derived features based on the enriched data. These derived features may include measures of transaction velocity, indicators of session integrity, and temporal relationships between user behavior and system-wide trends. The enrichment layer applies encoding, normalization, and transformation logic to ensure compatibility between live inference and the model training environment. Feature outputs are serialized according to a controlled schema and tagged with metadata to indicate feature lineage, transformation logic, and version information.

All operations performed within Data-Enrichment Layer 830 are subject to strict security and privacy constraints. Sensitive attributes such as payment data or personal identifiers are handled using encryption, tokenization, or secure enclave computing, depending on configuration. In multi-tenant environments, enrichment data obtained from one merchant's transaction cannot be made visible to other merchants unless authorized by policy. All enrichment steps, including API queries, feature generation, and intermediate outputs, may be logged to Analytics & Logging Store 880 to support auditability, transparency, and feature drift detection.

By converting a sparse transaction payload into a feature-rich, context-aware representation, Data-Enrichment Layer 830 enables downstream systems to make highly informed, adaptive decisions about reprocessing strategies. This component serves as the bridge between raw input data and intelligent modeling, transforming static transactional metadata into a dynamic, behavioral signal used to drive real-time routing and risk management.

In some embodiments, the system includes a Risk Model Ensemble 840 configured to evaluate enriched transaction data and produce a set of predictive outputs that inform downstream reprocessing decisions. Risk Model Ensemble 840 operates as the core decisioning engine in system 800 and applies machine learning techniques to determine whether a failed payment transaction, once enriched with contextual and behavioral data, has a sufficiently high likelihood of succeeding if reattempted. In addition to assessing success probability, the ensemble may estimate the cost and risk associated with executing a reauthorization and may contribute to routing strategy optimization.

The enriched feature vector output by Data-Enrichment Layer 830 is used as the primary input to Risk Model Ensemble 840. This feature vector may include categorical fields, numerical variables, and temporal features derived from device fingerprints, behavioral telemetry, issuer response history, and external enrichment sources. Prior to inference, the feature vector may be normalized, encoded, and version-tagged to ensure consistency across different model generations and to maintain compatibility between live prediction and training environments.

Risk Model Ensemble 840 may include a classification model trained to predict the likelihood that a given transaction, if reprocessed via an alternate execution path, will be authorized by the issuing bank. This classification output may be expressed as a bounded probability score, and may be accompanied by secondary labels identifying the most probable cause of the original decline. The classification model may be implemented using supervised learning algorithms such as gradient-boosted decision trees, logistic regression, or deep neural networks, depending on the size and structure of the feature set, the interpretability requirements, and the available training corpus.

In parallel with the classification model, Risk Model Ensemble 840 may include a regression model trained to estimate the projected cost or risk of pursuing the reauthorization. This cost estimate may incorporate factors such as anticipated chargeback exposure, issuer dispute probability, fraud detection sensitivity, and interchange or acquiring fees. In some deployments, the regression output is used to construct a risk-adjusted score that modifies or filters reprocessing decisions, particularly for transactions that fall near threshold boundaries or are flagged for elevated scrutiny.

To accommodate the non-deterministic and time-sensitive nature of issuer behavior, Risk Model Ensemble 840 may also include a reinforcement learning component configured to improve execution path selection over time. This component may receive feedback from successful and failed reauthorization attempts and update its policy accordingly to reflect changing network conditions, issuer-level idiosyncrasies, or dynamic merchant objectives. The reinforcement learning agent may be constrained by bounded exploration parameters to ensure safety and cost control, and may operate in conjunction with or in parallel to the main classification and regression models.

Each predictive output generated by Risk Model Ensemble 840 may be tagged with explanatory metadata to improve transparency and traceability. For instance, the system may generate feature attribution maps or saliency scores indicating which input variables most influenced the decision. These artifacts may be used internally for debugging and model tuning or externally for merchant reporting and dispute analysis. Model outputs may also include confidence bands or soft classification scores that support additional post-processing or policy gating logic.

Risk Model Ensemble 840 may be continuously retrained using labeled data collected via Analytics & Logging Store 880. As new transactions are processed and their outcomes become known, the system may update its training set, monitor for feature drift, and retrain one or more sub-models to ensure that performance remains stable in the face of evolving data distributions. Retraining may occur on a fixed schedule or be triggered by performance degradation, domain shift detection, or configuration updates initiated by operators or automated governance tools.

All inference and prediction steps performed by Risk Model Ensemble 840 may be logged with input hashes, output results, model version identifiers, and evaluation timestamps. These records may be persisted in a secure audit store and may support offline replay, failure reproduction, A/B testing, and regulatory disclosure requirements.

Risk Model Ensemble 840 thus enables the system to make adaptive, statistically grounded decisions about whether to reprocess a failed transaction, and if so, how to prioritize cost, probability, and risk. By leveraging learned patterns from historical data and integrating real-time signals from across system 800, this component functions as the intelligent core of the transaction recovery pipeline.

In some embodiments, the system includes an Execution-Path Selector 850 configured to determine how a previously declined payment transaction should be reprocessed following evaluation by Risk Model Ensemble 840. Execution-Path Selector 850 functions as a downstream orchestration layer that receives decision outputs such as predicted success probability and cost-of-risk, and uses those outputs to identify an optimal execution path for authorization. An execution path, as used herein, may correspond to a specific configuration of acquiring bank, merchant identification profile, routing logic, and other transaction parameters used in the formation of a new authorization request. Execution-Path Selector 850 may operate under latency-sensitive conditions, where routing decisions must be made in real time, or in deferred-mode contexts such as batch processing or scheduled retries.

Execution-Path Selector 850 may access a portfolio of candidate paths associated with New Merchant-of-Record Processor 860. Each path in the portfolio may be associated with a distinct merchant identification number, merchant category code, acquiring relationship, geographic jurisdiction, or network descriptor configuration. In certain embodiments, these paths may be precomputed and stored in a decision graph, whereas in other implementations, Execution-Path Selector 850 may evaluate paths dynamically based on model outputs and prevailing network conditions. The selector may access metadata associated with each candidate path to evaluate compatibility, including issuer acceptability, authorization history, chargeback profiles, or processing fees.

In some implementations, Execution-Path Selector 850 applies an optimization function that considers both the predicted success likelihood and the projected cost associated with reprocessing a transaction. This function may be used to compute a utility score for each eligible path, enabling the system to prioritize lower-risk, higher-probability routing decisions. In addition to model-driven scoring, Execution-Path Selector 850 may consider business rules or merchant-specific constraints, such as preferred acquiring banks, regulatory limitations, jurisdictional exclusions, or branding requirements. Routing preferences may be customized per merchant integration and may reflect commercial agreements, settlement SLAs, or fraud handling tolerances.

In some embodiments, Execution-Path Selector 850 is configured to recognize issuer-specific behaviors or network-level restrictions and to incorporate these patterns into the routing decision. For instance, the selector may maintain historical success rates per issuer-acquirer pairing, or it may identify combinations of descriptors and MCCs that have previously yielded higher authorization rates for a given card type. These behavioral profiles may be stored in an adaptive scoring matrix and updated based on ongoing transaction outcomes captured in Analytics & Logging Store 880. Where permitted, Execution-Path Selector 850 may also consider time-based routing logic, such as favoring specific processors during peak hours or altering preference during network degradation or scheduled maintenance windows.

Routing decisions made by Execution-Path Selector 850 may be deterministic or probabilistic. In probabilistic modes, the selector may introduce a weighted randomization component to support controlled experimentation or reinforcement learning objectives. Such probabilistic routing may be bounded by safeguards to ensure that transactions meeting specific risk criteria are always routed through compliant paths. In either case, Execution-Path Selector 850 produces a routing directive that defines the execution parameters for the subsequent reauthorization attempt. These parameters are passed to New Merchant-of-Record Processor 860, where they are instantiated as part of the authorization payload.

Execution-Path Selector 850 may log the selected path, the candidate paths evaluated, the scores computed, and the business rules or constraints applied during decisioning. These logs may be used to audit routing consistency, reproduce decisions during disputes, or perform comparative analysis across merchant cohorts. Logs may also feed back into model training workflows for Risk Model Ensemble 840 to inform path performance and reinforce successful strategies.

The design of Execution-Path Selector 850 enables system 800 to route reauthorization attempts through the most promising configuration based on real-time data and predictive analytics. By decoupling the path selection from the authorization submission process, the system preserves modularity, supports scalability, and maintains a flexible decision-making layer that can evolve independently of downstream transaction processing infrastructure.

In some embodiments, the system includes a New Merchant-of-Record Processor 860 configured to instantiate a new authorization request for a previously declined payment transaction using credentials and infrastructure associated with a merchant entity that is distinct from the originating merchant. New Merchant-of-Record Processor 860 receives a routing directive from Execution-Path Selector 850 and is responsible for formatting, submitting, and managing the resulting transaction under its own processing profile. From the perspective of the payment network, card issuer, and acquiring bank, the new authorization attempt appears as an independent transaction initiated by a separate merchant of record. This separation enables the system to bypass issuer-side heuristics associated with repeated attempts and allows the system to apply alternate descriptors, merchant category codes, and authorization strategies that may increase the likelihood of success.

New Merchant-of-Record Processor 860 may operate under one or more merchant identification numbers (MIDs) registered with acquiring banks across different card networks, jurisdictions, and transaction verticals. Each MID may be associated with a unique descriptor, risk classification, MCC, or authentication policy. In some implementations, Processor 860 maintains a portfolio of MIDs and selects an appropriate one for each reprocessing attempt based on routing metadata provided by Execution-Path Selector 850. The selected MID governs how the authorization is submitted, how it is branded, and how downstream settlement and clearing will be handled.

To construct a valid authorization payload, New Merchant-of-Record Processor 860 retrieves the enriched transaction data, the selected execution path, and any additional customer inputs collected through Customer Interaction Module 865. Where necessary, Processor 860 may translate or re-tokenize payment credentials using a vault mapping service or a network tokenization provider. This translation ensures compatibility between the token format used by the original merchant and the one required by the target acquiring processor or card network. If a 3-D Secure challenge or frictionless flow is required, the processor may retrieve the appropriate authentication values from a previously completed session or initiate a new authentication request prior to authorization.

Processor 860 formats the transaction request according to the protocol supported by the designated acquirer. This may include ISO 8583 for legacy gateway integrations, JSON-based APIs for modern processors, or SDK-based payloads in mobile environments. In addition to core fields such as PAN/token, amount, and currency, the payload may include authorization parameters such as soft descriptor, ECI flag, AVS/CVV results, recurring flag, merchant country, and authentication outcome fields. In some cases, Processor 860 may introduce deliberate variation in these fields—such as altering the MCC, modifying the descriptor, or adjusting capture delay parameters—to optimize success rates.

Once the authorization request is submitted, Processor 860 receives and parses the response. If the transaction is approved, Processor 860 may proceed with capture immediately or defer capture based on merchant configuration or fulfillment status. The capture policy may vary based on MID-level configuration, risk score, or customer interaction outcome. If the transaction is declined, Processor 860 may log the response code, issuer explanation, and any accompanying metadata. In some embodiments, Processor 860 may attempt a retry through a secondary path, subject to policy constraints and reinforcement learning recommendations.

New Merchant-of-Record Processor 860 assumes full liability for the transaction, including the risk of fraud, chargebacks, non-settlement, or dispute resolution. From a contractual standpoint, the original merchant does not appear on the clearing or settlement documentation, and no financial activity is processed through their MID. This separation allows Processor 860 to implement tailored fraud controls, dispute evidence templates, refund policies, and customer support workflows that are distinct from those used by the merchant. All transaction events and outcomes are logged to Analytics & Logging Store 880 for audit, training, and SLA monitoring purposes.

In some embodiments, New Merchant-of-Record Processor 860 may operate in a modular architecture that supports different routing and submission policies per region, card brand, or payment method. For example, the processor may be configured to route high-risk transactions through MIDs with enhanced fraud tolerance and route low-risk transactions through cost-optimized acquirers. In addition, Processor 860 may support fallback or rollover logic to alternate acquiring banks in the event of network errors, response delays, or issuer-level outages.

The architecture of New Merchant-of-Record Processor 860 enables system 800 to isolate recovery transactions from the original merchant context, apply alternate execution strategies, and improve overall reprocessing success rates. This modularity supports scalable transaction recovery, legal and regulatory flexibility, and the implementation of contractually distinct financial products such as factoring, settlement pre-purchase, or post-decline risk assumption.

In some embodiments, the system includes a Customer Interaction Module 865 configured to facilitate secure, real-time engagement with an end user device 812 during or after the reprocessing of a failed payment transaction. Customer Interaction Module 865 enables the system to request and collect supplemental data from the cardholder, such as corrected payment credentials, missing verification elements, or authentication responses. This module operates under the control of system 800 and may be invoked conditionally based on the output of Risk Model Ensemble 840, routing constraints imposed by Execution-Path Selector 850, or issuer-specific requirements associated with the selected reauthorization path.

Customer Interaction Module 865 may be triggered when a failed transaction is deemed salvageable but incomplete. For example, if a high success likelihood is predicted but the available data is missing a CVV value or has a mismatched billing address, the module may initiate a remediation workflow directed to end user device 812. In other cases, interaction may be prompted by an issuer requiring a step-up challenge or when an acquirer mandates address verification or cardholder authentication before proceeding with the authorization. The module supports both synchronous and asynchronous interaction flows and may be embedded directly into a merchant's checkout interface or rendered via a hosted session initiated through a secure link.

The interaction surface presented by Customer Interaction Module 865 may be deployed in the form of an inline iframe, a modal overlay, a redirect to a hosted page, or a progressive form presented via a JavaScript SDK integrated into merchant platform 810. The module may prompt the user for specific fields such as CVV, card expiration date, postal code, or full billing address. In configurations that support authentication, Customer Interaction Module 865 may initiate flows that support multifactor authentication, such as SMS one-time passwords, push-based device verification, biometric challenges, or 3-D Secure (3DS) authentication in either frictionless or challenge mode. In each case, the module dynamically renders appropriate UI based on transaction metadata, issuer preference, and device capability.

All user input collected via Customer Interaction Module 865 is securely transmitted to system 800 using encrypted transport and stored or tokenized in compliance with PCI-DSS and data privacy regulations. Sensitive fields may be rendered using PCI-compliant hosted input elements, tokenized via direct-to-vault workflows, or handled within secure browser contexts using cross-domain isolation techniques. The module may incorporate anti-fraud controls such as input validation, behavioral biometrics, and anomaly detection based on user keystroke dynamics, mouse movement, or interaction timing.

In asynchronous configurations, Customer Interaction Module 865 may be initiated outside of the original transaction session. For example, following a transaction failure, the system may send an email or SMS message to the customer containing a deep link to a secure remediation interface hosted by the system. When the user clicks the link, a time-bound session is launched that pre-fills known information and requests the missing or corrected inputs. Upon successful submission, the module validates the data, optionally enriches the transaction again, and resumes processing at Risk Model Ensemble 840 or New Merchant-of-Record Processor 860, depending on system policy.

Interaction events processed by Customer Interaction Module 865 may include successful remediation, partial submission, timeout, customer abandonment, or explicit refusal. Each outcome may be logged in Analytics & Logging Store 880 with associated metadata including timestamps, device identifiers, input quality scores, and interaction duration. This information may be used to monitor system performance, identify user experience bottlenecks, and calibrate future thresholds for automated fallback.

Customer Interaction Module 865 is configurable across multiple dimensions. System operators may define conditions for when interaction should be initiated, how long a session remains valid, what fallback channels are permissible, and what authentication policies should be enforced per merchant, issuer, or routing path. The system may dynamically adjust prompts based on user behavior, risk assessment, or previous response outcomes. Merchants may also customize the branding, messaging, and sequence of prompts rendered through the module, provided that all security and compliance requirements are met.

Customer Interaction Module 865 enables system 800 to seamlessly bridge automated decisioning with customer input, allowing for improved reprocessing outcomes when additional information is required. It avoids the need for separate merchant communications or out-of-band retries, reducing friction and abandonment, and improving the end-to-end success rate of transaction recovery efforts.

In some embodiments, the system includes an Outcome Interface 870 configured to communicate the final disposition of a declined transaction after it has been evaluated, optionally enriched, and either reprocessed or rejected. Outcome Interface 870 enables system 800 to deliver structured resolution data to merchant platform 810, including approval results, decline reasons, routing decisions, and any remediation requirements that may apply to the transaction. The module provides a reliable, authenticated interface through which the originating merchant can retrieve actionable information about the status of its transactions without requiring direct control over the underlying reprocessing infrastructure.

Outcome Interface 870 may support multiple delivery channels, including webhook-based push notifications, synchronous API polling, and report-based export mechanisms. In webhook mode, the system initiates a POST request to a merchant-supplied callback URL when a transaction reaches terminal status. Payloads may include a transaction identifier, a decision label (such as APPROVED, DECLINED, or ACTION_REQUIRED), a timestamp of resolution, and additional metadata such as issuer response codes, execution path details, or model score summaries. Webhooks may be cryptographically signed to verify authenticity and may include anti-replay tokens, timestamps, and nonce values to support secure processing.

In polling mode, merchant platform 810 may query the system using a synchronous GET request to retrieve the status of a previously submitted transaction. The query may include a unique tracking token returned by Payment-Decline Intake API 815 at ingestion, or a merchant-supplied reference identifier. Outcome Interface 870 returns a structured response containing the current or final status of the transaction and may also include optional diagnostic fields, latency metrics, and model-generated confidence indicators. These endpoints are designed to support high-availability workloads and may be used as a fallback mechanism if webhook delivery is not possible or is declined by the merchant.

In cases where a transaction requires additional action before a final decision can be rendered, Outcome Interface 870 may return an ACTION_REQUIRED status. This response may include a pointer to a hosted remediation flow, typically generated by Customer Interaction Module 865, allowing the customer to provide missing data or complete authentication. The remediation link may be constructed with a time-limited session token and may be embedded in merchant-side UI or delivered via email or SMS. Once the customer completes the required action, the system re-evaluates the transaction and updates its status via Outcome Interface 870.

The structure and schema of outcome responses may be version-controlled to support compatibility across different merchant integrations and SDK versions. The system may publish a schema registry or change notification service to alert merchants of deprecations or additions to the response format. Payloads may also include optional extensions such as fraud detection scores, BIN metadata, or enrichment source indicators, depending on merchant configuration and contractual scope.

Outcome Interface 870 may be tightly integrated with downstream business systems operated by the merchant, such as order management systems, CRM platforms, and analytics dashboards. In some embodiments, the system includes reconciliation tags or metadata identifiers that allow transaction status records returned by Outcome Interface 870 to be automatically linked with upstream records submitted by merchant platform 810. These records may be logged and retained in Analytics & Logging Store 880 to support root cause analysis, SLA compliance verification, and dispute tracking.

The design of Outcome Interface 870 enables merchants to receive decision results in a structured, secure, and latency-sensitive manner without requiring direct access to reprocessing internals. By abstracting the complexity of transaction evaluation and routing, the interface provides a clean separation between decisioning infrastructure and merchant-facing integration, allowing system 800 to maintain flexibility, upgradeability, and auditability across its full processing stack.

In some embodiments, the system includes an Analytics & Logging Store 880 configured to persist, aggregate, and expose structured and semi-structured data generated throughout the transaction reprocessing lifecycle. Analytics & Logging Store 880 serves as a central observability and auditability layer within system 800 and supports a wide range of internal and external use cases, including performance monitoring, model training, operational debugging, fraud analytics, and compliance reporting. The store is designed to operate at high throughput and low latency, handling the volume and velocity of events generated by modules such as Payment-Decline Intake API 815, Risk Model Ensemble 840, Execution-Path Selector 850, and New Merchant-of-Record Processor 860.

Analytics & Logging Store 880 may be implemented as a distributed storage system capable of supporting multi-tenant partitioning, queryable logs, and long-term retention policies. The underlying storage infrastructure may include columnar data warehouses, append-only log systems, time-series databases, or object stores, depending on the class of data and its access requirements. Each record ingested into the store may be tagged with a merchant identifier, transaction reference, processing phase, timestamp, and schema version to facilitate efficient filtering, indexing, and retrieval.

At each stage of the transaction pipeline, system 800 emits structured log entries containing relevant metadata. For example, Payment-Decline Intake API 815 may log authentication outcomes, schema validation results, and submission latency. Eligibility Engine 820 may emit rule evaluation summaries and eligibility decisions. Data-Enrichment Layer 830 may log enrichment source latencies, feature transformation identifiers, and behavioral fingerprint resolutions. Risk Model Ensemble 840 may produce prediction values, model version tags, and explanation artifacts. Outcome Interface 870 may record webhook delivery status, polling timestamps, and decision timestamps. All of these records are ingested by Analytics & Logging Store 880 for unified visibility.

Analytics & Logging Store 880 also supports the generation of labeled data sets for model development. As transactions are resolved—whether successfully reprocessed or ultimately declined—the store maintains ground-truth annotations that may be used to retrain models, recalibrate thresholds, or fine-tune path selection logic. The system may expose this data through batch export mechanisms, secure query interfaces, or integration with downstream data science platforms. Model training pipelines may access this data under version control, and training runs may be tracked against dataset hashes to ensure reproducibility.

To support merchant transparency and compliance requirements, Analytics & Logging Store 880 may expose metrics and logs via dashboards, alerts, and APIs. These endpoints may include key performance indicators such as recovery rates, average model scores, routing decisions by issuer or geography, and customer interaction success rates. Merchants may use this information to evaluate system performance, optimize customer flows, or respond to disputes and inquiries. Internal operators may monitor these same indicators to detect regressions, data quality issues, or anomalous behavior in the transaction pipeline.

Access to records stored in Analytics & Logging Store 880 may be governed by role-based access control policies and data governance frameworks. Sensitive fields may be encrypted at rest and in transit, and data may be redacted, masked, or tokenized according to jurisdictional or contractual requirements. Retention policies may be defined globally or per-merchant, and may include both soft and hard deletion workflows to support regulatory frameworks such as GDPR, CCPA, or PSD2. Audit trails may record every access to or modification of logged data, enabling provable compliance and forensic analysis.

Analytics & Logging Store 880 plays a critical role in maintaining the reliability, explainability, and adaptability of system 800. By capturing a complete historical record of system behavior, model decisions, and user interaction outcomes, this module enables continuous learning, robust compliance, and transparent performance benchmarking across the transaction recovery platform.

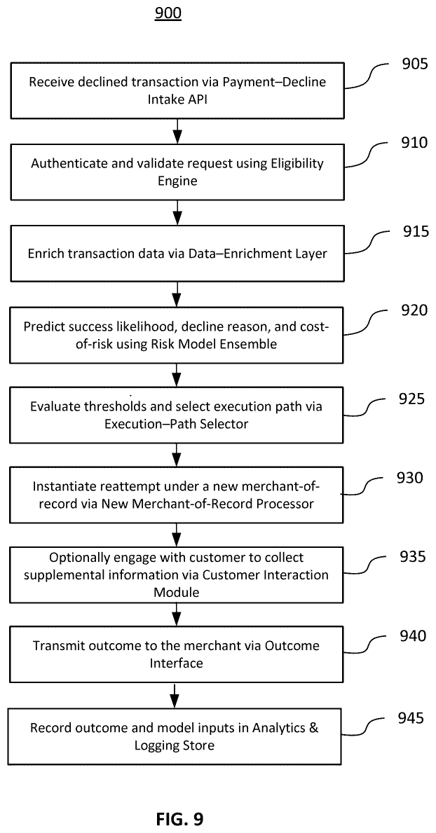

In some embodiments, the components of system 800 described above cooperate to perform a method for intelligently reprocessing declined payment transactions. FIG. 9 illustrates an exemplary method that may be implemented by one or more components of system 800, including, for example, Payment-Decline Intake API 815, Eligibility Engine 820, Risk Model Ensemble 840, and New Merchant-of-Record Processor 860. The steps of the method may be executed in real time or asynchronously, and may be performed in the order shown or in a different order, depending on transaction attributes, network configuration, and system policy. Each step is described below with reference to the corresponding components of FIG. 8 and may include sub-processes or decision logic omitted from the figure for clarity.

FIG. 9 is a flow diagram that illustrates an exemplary method 900 for reprocessing a declined payment transaction, in accordance with embodiments of the present invention. The method 900 may be implemented by one or more components of the system architecture 800 described in FIG. 8, including but not limited to the Payment-Decline Intake API 815, Risk Model Ensemble 840, and New Merchant-of-Record Processor 860. In some embodiments, the steps of method 900 may be performed sequentially, in parallel, or in a conditional branching pattern, depending on system configuration and transaction attributes. For example, the FlexCharge server 105 may execute logic corresponding to one or more of the enrichment, prediction, and routing steps shown in method 900, while interacting with external merchant systems, payment gateways, and customer devices. Each step of the method is described in greater detail below with reference to its corresponding labeled operation.

At step 905, the system receives, via the Payment-Decline Intake API 815, a request containing transaction data associated with a previously declined payment attempt. The declined transaction may originate from a customer-initiated transaction (CIT) or a merchant-initiated transaction (MIT), and may be submitted by the merchant's order management system, payment processor, or integration middleware acting on the merchant's behalf. The data transmission occurs over a secure channel, typically using HTTPS with TLS encryption, and may follow one of several supported interface paradigms, including RESTful JSON payloads, gRPC streams, or message queue ingestion (e.g., AMQP, Kafka).

The inbound payload may include a combination of required and optional fields that encode metadata about the failed transaction. Required fields may include: a unique merchant transaction identifier; a merchant account ID or API key; a masked or tokenized representation of the payment instrument (e.g., PAN token or card alias); transaction amount; transaction currency; timestamp of the original authorization attempt; and a decline code or failure reason received from the issuing bank or payment processor. Optional fields may include customer identifiers (e.g., hashed email address, phone number, or customer reference ID), billing address components, IP address of the client device, and session telemetry such as browser fingerprint, device ID, or user-agent string.

In some embodiments, the merchant may also submit contextual metadata such as the merchant's platform type (e.g., mobile app, browser, point-of-sale terminal), the originating country or region, and indicators of customer status (e.g., returning customer, guest checkout). Where the merchant has integrated client-side instrumentation such as SenseJS or an equivalent telemetry library, the API payload may further include a precomputed device fingerprint hash or a session identifier linking to asynchronously collected device attributes. This linkage allows enrichment processes to operate in a non-blocking fashion after initial ingestion.

The API is designed to be idempotent, meaning that repeated submission of the same transaction using a consistent idempotency key will not result in redundant processing. Idempotency keys may be supplied explicitly by the merchant or automatically derived from stable transaction fields. In cases where a duplicate submission is detected, the system may return a cached result or acknowledgment token rather than reinitiating downstream workflows. This mechanism is particularly useful in batch-processing scenarios or where merchants implement retry-on-failure logic in their integration stack.

Transaction ingestion at this stage is accompanied by authentication and authorization checks, described further in step 910. However, at a protocol level, the system may immediately validate the structure of the request payload using a schema registry, apply rate-limiting rules based on merchant profile and endpoint classification, and enqueue the normalized transaction data in a staging buffer for eligibility evaluation. Each request is timestamped upon receipt, assigned a system-side evaluation identifier (e.g., evaluation_id), and recorded in an append-only ingestion log for observability and traceability purposes.

In some implementations, the system may support alternative ingestion modalities beyond single-transaction API calls. For example, batch submission endpoints may accept newline-delimited JSON (NDJSON), compressed CSV files, or binary formats such as Avro or Protobuf. These interfaces allow merchants to submit bulk failed transaction data for asynchronous evaluation and are typically accompanied by metadata headers indicating batch size, encoding format, and submission context.

Accordingly, step 905 serves as the formal entry point for declined transactions into the reprocessing workflow, transforming externally sourced failure events into normalized, authenticated, and traceable system records eligible for evaluation, enrichment, and potential recovery.

At step 910, the system authenticates the requestor submitting the declined transaction and validates the structural and contextual integrity of the received payload using logic implemented in Eligibility Engine 820. This step ensures that only authorized merchant systems may invoke the declined transaction evaluation service, and that the associated data meets required standards for format, completeness, and eligibility preconditions before progressing further into enrichment and analysis.

Authentication may be performed using one or more of several supported mechanisms depending on the merchant's integration tier, including OAuth 2.0 bearer tokens, HMAC-signed request headers, client-side TLS certificates (mTLS), or statically issued API keys with associated scopes. Each authentication credential is mapped to a merchant-specific service profile in the system's identity registry, which defines permitted endpoints, rate limits, and feature entitlements. Failed authentication attempts are logged with request fingerprints and may result in temporary suspension or blacklisting of offending clients.

Following successful authentication, the system proceeds to validate the payload structure against a registered schema version corresponding to the merchant's integration profile. This schema may define mandatory fields (e.g., transaction ID, amount, response code), conditional fields (e.g., billing ZIP), and mutually exclusive field groups (e.g., PAN token or network alias, but not both). Field-level validations may include type checking, format normalization (e.g., ISO 8601 timestamps, currency codes per ISO 4217), and cross-field consistency checks. Transactions failing schema validation are rejected with a structured error response and do not proceed further in the pipeline.

Beyond syntactic checks, the system may perform a contextual validation of the transaction using merchant-specific eligibility criteria stored in a policy registry. These criteria may include transaction volume limits, daily monetary caps, geographic eligibility, BIN-specific exclusions, or fraud-risk flag thresholds. For example, a merchant operating under a North America-only agreement may be blocked from submitting transactions with a detected cardholder country outside the permitted scope. Similarly, a program-configured quota (e.g., 10,000 evaluations per hour) may cause a transaction to be deferred or rate-limited if the merchant has exceeded the limit.

The system may also detect transaction duplication or replay attempts at this stage by computing a deterministic hash of key identifying fields—such as transaction ID, masked PAN, timestamp, and merchant ID—and comparing this hash to a deduplication cache or ingestion ledger. If a matching record is found within a predefined time window (e.g., 10 minutes), the system may suppress redundant processing and return the outcome of the original evaluation or a specific duplicate-notification response.

In some embodiments, the validation process may include invocation of a rules engine that applies additional gating logic based on real-time parameters, such as processor health, acquirer availability, or system load. For example, the system may temporarily reject transactions intended for reprocessing through a specific acquirer if that acquirer is experiencing elevated latency or API degradation. These environmental factors may be monitored via service health metrics and fed into validation rules dynamically.

All outcomes of the authentication and validation stage are recorded in a structured decision log, including a status code, rejection reason (if any), time of evaluation, and a unique trace identifier. These records are persisted in the Analytics & Logging Store 880 for auditability, observability, and merchant-facing transparency. Transactions that pass authentication and validation successfully are annotated accordingly and routed to the Data-Enrichment Layer 830 for further processing in step 915.

At step 915, the system enriches the validated transaction data with supplemental contextual, behavioral, and third-party attributes to enhance the predictive and decision-making fidelity of downstream models. The enrichment process transforms the relatively sparse information received from the merchant into a dense, feature-rich representation suitable for machine learning evaluation and execution path selection. Enrichment may occur synchronously or in a partially asynchronous manner depending on data availability, system configuration, and merchant latency constraints.

The enrichment pipeline may include connectors to both internal telemetry sources and external risk intelligence providers. Internally, the system may leverage instrumentation collected at the time of transaction initiation via embedded client-side scripts, such as a JavaScript telemetry library (e.g., SenseJS) integrated into the merchant's checkout flow. These scripts may capture and transmit device and session data including browser type, operating system version, screen resolution, time zone offset, client IP address, and device ID. In some configurations, this data is hashed or tokenized at the edge and securely linked to the transaction payload at the time of submission to the API.

Externally, the system may query or subscribe to third-party data providers to obtain risk scoring, identity validation, and fraud intelligence signals. These may include IP reputation scores, disposable email address detection, device reputation lookups, anonymizer usage flags (e.g., proxy, VPN, Tor), and account verification results for phone numbers or email addresses. Additional data may be obtained from credit bureaus, watchlists, payment network services (e.g., 3-D Secure metadata), and BIN-level databases that provide attributes such as issuer bank, card type (credit/debit/prepaid), card brand, issuing country, and commercial or consumer classification.

In some embodiments, the system computes a set of behavioral and velocity features derived from historical system activity. For example, the number of distinct cards used with the same billing address over the past 24 hours, or the number of failed transactions from the same device fingerprint across all merchants within a trailing time window, may be included in the feature vector. These values are typically computed using pre-aggregated or stream-processed logs maintained in a high-performance key-value store or streaming analytics engine.

The system may also generate hashed identity or behavioral fingerprints that uniquely represent a combination of transaction attributes. For example, the combination of hashed email address+billing ZIP+card BIN may form a composite identity key that is matched against historical patterns. These fingerprint-based lookups allow the system to contextualize the transaction against long-range fraud and performance trends, such as whether the same customer identity has been associated with previous declines, chargebacks, or successful reattempts.

In addition to retrieving raw values, the system may compute derived features such as time-of-day bands, transaction recency scores, entropy measures for text fields (e.g., address or name), or rank-ordered feature combinations based on prior model saliency. Each derived feature is associated with a versioned feature definition and a transformation function, ensuring consistency between real-time inference and offline model training.

All enriched data is consolidated into a structured feature vector—a dense multidimensional array of typed values—tagged with a schema version and linked to the original transaction identifier. This vector serves as the canonical representation of the transaction for use in step 920, where machine learning models perform predictive analysis. The enrichment process is monitored with real-time instrumentation to detect anomalies, missing data, timeouts, and API errors, and any fallback behavior (e.g., default scores or null substitution) is recorded and flagged in the transaction metadata.

Finally, the enriched feature vector, along with associated audit metadata (e.g., data source provenance, enrichment version hashes, latency measurements), is persisted to a transient data store or in-memory cache pending handoff to the Risk Model Ensemble 840 for evaluation.

At step 920, the system uses the enriched transaction data to generate a finalized feature vector and applies one or more predictive models to evaluate the likelihood that the declined transaction can be successfully reprocessed. This step represents the core of the decisioning process, where machine learning models operate on the multidimensional input space derived in step 915 to produce one or more outputs, including a success probability score, an expected decline reason classification, and a cost-of-risk estimate. These outputs guide downstream routing and determine whether further action—such as reauthorization or customer interaction—should be taken.

The feature vector at this stage is a normalized, schema-controlled array of numerical and categorical values, including device fingerprint metrics, issuer identifiers, 3-D Secure results, historical behavior indicators, velocity aggregates, IP intelligence scores, and derived transformations such as time-based trends or risk-normalized encodings. Features may be one-hot encoded, bucketized, scaled, or otherwise pre-processed in accordance with the input expectations of the model ensemble in use. The system ensures compatibility between training and inference by tracking feature schema versions, transformation logic, and model binding configurations.

The model ensemble used at this stage may include multiple machine learning components trained to serve distinct but complementary objectives. A primary classification model is typically used to predict the binary outcome of a reprocessed transaction—i.e., whether a reattempt under a different execution path will be authorized by the issuing bank. This model may be implemented using logistic regression, gradient-boosted decision trees (e.g., XGBoost, LightGBM), or deep learning architectures depending on the feature richness, performance requirements, and deployment constraints. Model input is fed through a prediction service, which may operate synchronously in-memory, on a GPU-accelerated node, or in a horizontally scaled inference cluster.

In parallel, a regression model may be used to estimate the cost of pursuing a successful reattempt. This cost-of-risk output may be represented as a real-valued scalar, incorporating projected chargeback exposure, processing fees, customer support cost, and dispute remediation risk. The regression model may be trained using historical outcome data with weighted loss functions to prioritize high-variance or high-liability scenarios. The system may apply calibration and post-processing logic to transform the raw cost estimate into a normalized score compatible with risk policy thresholds.

In some embodiments, the system may also employ reinforcement learning techniques to influence reprocessing strategies. These models may be trained to maximize long-term success rates or net recovery value across a series of reprocessing events, incorporating feedback from previous attempts, execution path performance, and changing issuer behavior. Reinforcement learning agents may be used to update path preferences, trigger reauthorization delays, or adjust feature weighting in real-time.

In addition to producing the core predictive outputs, the model ensemble may generate attribution signals or confidence scores. For example, SHAP (SHapley Additive explanations) values or permutation feature importance scores may be computed to identify the most influential variables for a given prediction. These interpretability artifacts are logged alongside the model outputs and may be exposed via dashboards or merchant support tools for transparency.

Each model invocation is logged with metadata including model version, prediction latency, input vector checksum, and prediction confidence band. These logs support A/B testing, model performance tracking, and compliance verification. Where multiple models are used in combination (e.g., ensemble stacking or weighted voting), the system records the contribution of each model to the final decision output.

The final result of this step is a structured scoring object associated with the transaction, containing (i) a predicted success probability score p∈[0, 1]; (ii) an expected decline reason label (e.g., FRAUD_FLAG, INSUFFICIENT_FUNDS, VELOCITY_THRESHOLD); and (iii) an optional scalar representing the estimated cost-of-risk. These outputs are passed to the next decision gateway in step 925 to determine whether the transaction should proceed to execution under a new merchant of record or be declined without further processing.

At step 925, the system evaluates the predictive outputs generated in step 920 against configurable decision thresholds, as applied by Execution-Path Selector 850, to determine whether the declined transaction should proceed to reauthorization under a new merchant-of-record. This step acts as a gating mechanism that integrates statistical predictions, merchant risk policy, and real-time system constraints into a single routing decision. The result of this evaluation is binary: either the transaction is considered eligible for reprocessing and forwarded to the execution layer (step 930), or it is rejected, and a terminal outcome is returned to the originating merchant.

The primary input to the gateway is the predicted success probability score p E [0, 1], representing the likelihood that the transaction, if reprocessed via an alternative execution path, will be authorized by the issuing bank. This score is compared against a configurable threshold θ, which may be defined globally, per-merchant, per-program, or dynamically adjusted based on traffic conditions or model confidence distributions. If the score p exceeds the threshold θ, the transaction qualifies for reprocessing subject to cost constraints. If p≤0, the system deems the transaction insufficiently likely to succeed and returns a DECLINED status to the merchant via the Outcome Interface (step 940), without incurring further processing costs or customer friction.

In parallel, the system evaluates a cost-of-risk estimate c produced by the regression model in step 920. This scalar value reflects the projected cost of pursuing the reattempt, including expected chargeback losses, processor fees, dispute remediation labor, and reputational risk. This value may be compared against a configurable cost ceiling k defined in the merchant's service agreement or derived from historical acceptable risk profiles. If c exceeds κ—even when p>θ—the transaction may still be rejected, flagged for manual review, or queued for reprocessing at a later time under a different routing configuration.

In certain embodiments, the system may apply additional business rules, such as composite scoring bands, dual-threshold models (e.g., green/yellow/red classification), or path-dependent exclusion logic. For instance, a transaction with p in the “yellow” range (e.g., 0.6<p<0.75) may proceed only if the customer is not new or if a low-risk acquirer is available. These business rules may be implemented using an interpretable policy engine or embedded decision trees integrated with the risk model outputs.

To support transparency and reproducibility, the system logs each threshold evaluation and decision outcome in a structured trace object. This trace may include the score values, threshold values, policy version IDs, feature snapshots, and user-context metadata (e.g., merchant ID, transaction ID, timestamp). This log entry is persisted to the Analytics & Logging Store 880 and may be exposed in reporting APIs or audit dashboards for post-decision review, merchant support inquiries, or compliance analysis.

If the transaction is rejected at this step, the system immediately transitions to step 940, returning a DECLINED response to the merchant. If the transaction is approved, the system proceeds to step 930, where a new authorization attempt is instantiated under a new merchant-of-record via the selected execution path.

At step 930, the system instantiates a new payment authorization attempt using credentials, infrastructure, and execution parameters associated with a new merchant-of-record. This step is executed when the transaction has been deemed both likely to succeed and within the acceptable cost-of-risk bounds, as determined in step 925. The reauthorization process is handled by the New Merchant-of-Record Processor 860, which operates independently from the originating merchant's environment and assumes full responsibility for transaction submission, network interaction, and liability exposure.

The new merchant-of-record is represented by a distinct legal and operational entity that holds one or more merchant identification numbers (MIDs) with acquiring banks. These MIDs may be optimized for specific industries, card brands, geographic regions, or risk profiles. The processor selects an appropriate MID and execution path based on the directive produced by the Execution-Path Selector 850, which may consider factors such as acquirer availability, historical issuer responsiveness, network tokenization compatibility, and configured routing weights.

The processor assembles a new authorization request by combining enriched transaction data (from step 915), predictive scoring metadata (from step 920), and execution path directives. Depending on the selected path, the processor may customize elements of the request such as the soft descriptor, merchant category code (MCC), presentment country, currency code, capture window, or authentication flags. If the selected path supports or requires 3-D Secure (3DS), the processor may retrieve and attach a cryptographically signed authentication payload or dynamically initiate a challenge flow if frictionless authentication is not possible.

Payment credentials included in the authorization request may be derived from the original payload or substituted via token mapping. In some embodiments, the processor maintains a secure vault or token exchange that allows PAN tokens issued to the original merchant to be safely transposed into a reprocessable format acceptable to the new merchant-of-record. Alternatively, network tokens (e.g., Visa Token Service, Mastercard MDES) may be leveraged to facilitate credential portability and reduce data exposure.

The authorization request is transmitted to the designated acquiring bank or payment gateway using protocols such as ISO 8583, RESTful APIs, or network-specific SDKs. The processor monitors for response codes, message acknowledgments, timeouts, or issuer referrals. All communication is logged with correlation IDs and latency measurements to support observability, debugging, and network SLA monitoring.

Upon receipt of the issuer's response—whether approved, declined, or pending additional action—the processor records the outcome and passes the result downstream to step 940. If approved, the transaction proceeds to settlement and clearing under the new merchant entity. The processor assumes responsibility for all associated obligations, including funding reconciliation, chargeback processing, network compliance, and dispute resolution. The original merchant does not interface with the acquirer or issuing bank at any point during this phase.

The processor may optionally invoke post-authorization hooks, such as webhook notifications, internal alerting systems, or capture scheduling workflows, depending on merchant configuration. In some scenarios, the processor may defer capture until fulfillment confirmation or other downstream triggers are received. All transaction metadata, routing decisions, response codes, and model inputs are logged to the Analytics & Logging Store 880.

Accordingly, step 930 operationalizes the system's core value proposition—reprocessing a failed payment under a new merchant context using enhanced data and dynamic routing—to maximize the likelihood of successful authorization while insulating the original merchant from financial and regulatory risk.

At step 935, the system may initiate an interactive session with the customer associated with the declined payment transaction for the purpose of collecting supplemental information or performing secondary authentication. This step is conditionally executed when the predicted likelihood of success—while above the reprocessing threshold—is marginal or within a confidence margin that indicates the transaction may benefit from customer remediation. The trigger for this step may also arise from execution-path requirements, such as acquirer policies that mandate address verification (AVS), card verification value (CVV), or multi-factor authentication prior to authorization submission.

The Customer Interaction Module 865 is responsible for orchestrating this engagement and may operate through multiple channels and integration modes. In synchronous flows, such as during checkout, the module may render an inline or modal interface embedded within the merchant's page via JavaScript or iframe. This interface may prompt the customer to re-enter CVV, update expiration date, confirm billing address, or select an alternate payment instrument. The module may also leverage previously captured telemetry to auto-populate form fields or validate entries in real time.

In asynchronous scenarios—such as when the customer has abandoned the checkout flow or the decline occurred during a merchant-initiated transaction (e.g., a subscription)—the system may initiate an out-of-band remediation workflow. This may include sending an email, SMS, push notification, or in-app message containing a secure, time-limited URL that allows the customer to resume the transaction in a hosted recovery flow. The recovery interface may include branding from the original merchant, explanatory messaging, and contextual prompts based on the specific missing or invalid data points identified during enrichment and modeling.

Where supported, the module may integrate with 3-D Secure (3DS) frameworks and initiate a step-up authentication flow. This may include redirecting the customer to the issuer's Access Control Server (ACS), presenting a challenge interface, and capturing authentication results (e.g., CAVV, ECI, XID) for inclusion in the authorization payload submitted in step 930. The module may also support biometric authentication, mobile device verification, or real-time document scanning depending on configuration and issuer capabilities.

All data captured during this step is handled in compliance with PCI DSS and applicable data privacy regulations. Sensitive fields such as CVV and expiration date are isolated within tokenization environments or collected via secure iFrame components rendered from a PCI-certified subdomain. Data is transmitted over encrypted channels and not persisted beyond the duration necessary to complete the reauthorization process. The system may include passive behavioral analytics (e.g., keystroke timing, mouse movement) to detect potential bots or synthetic identities and feed this signal into a supplemental risk model.

Interaction outcomes are categorized and logged with a result code indicating success, partial completion, abandonment, timeout, or failure due to input validation. If the required information is obtained and validated, the system may update the feature vector, re-score the transaction using step 920 logic, and reinvoke step 930 with the revised input. If the customer abandons the session or provides invalid data, the system may return an ACTION_REQUIRED or DECLINED outcome to the merchant in step 940 depending on merchant policy.

The decision to invoke customer interaction—and the content of the remediation prompts—may be fully configurable at the merchant level or dynamically controlled by system policy based on transaction risk tier, data completeness, issuer expectations, and historical response rates. Merchants may also opt to suppress customer-facing flows under certain conditions (e.g., for high-value subscribers or internal accounts), in which case the system proceeds directly to outcome delivery.

Thus, step 935 provides a mechanism for recovering transactions that would otherwise fail due to incomplete, stale, or low-confidence data, enhancing system flexibility and maximizing salvageable volume while maintaining a streamlined user experience.

At step 940, the system transmits a final outcome message to the originating merchant or platform, providing definitive resolution information for the evaluated declined transaction. This outcome may be the result of a successful reauthorization performed under the new merchant-of-record (step 930), a decision to forego reprocessing due to insufficient success probability or excessive cost (step 925), or a failure to complete required customer interaction (step 935). The purpose of this step is to inform the merchant in a timely, reliable, and machine-readable manner of the status of the recovery attempt so that appropriate downstream actions—such as order fulfillment, retry suppression, or customer communication—can be taken.

The system supports multiple delivery modes for outcome communication. In many embodiments, the preferred mechanism is a webhook interface: a server-initiated HTTP POST request sent to a merchant-specified callback URL. The payload of the webhook may include fields such as the system-issued evaluation ID, original merchant transaction reference, final decision code (e.g., APPROVED, DECLINED, ACTION_REQUIRED), processor or issuer response code, selected execution path metadata, and optional fields describing the reason for the outcome. The webhook payload is typically signed using HMAC or JWT-based authentication headers and may include timestamps, nonce values, and message digests to support verification and replay protection.

To support integration flexibility and resilience against delivery failures, the system may offer a RESTful polling interface as an alternative or backup channel. Merchants may issue periodic GET requests to a/results or/status/{evaluation_id} endpoint, authenticated via token or key-based credentials. The response schema mirrors that of the webhook and may include additional diagnostic fields such as model confidence score, enrichment source statuses, and routing configuration IDs. Polling intervals and retention durations may be configurable per merchant or defaulted based on system-wide policy.

When the outcome is APPROVED, the payload may include clearing information such as the new merchant-of-record's authorization ID, MID, approval timestamp, and clearing descriptor string. These fields enable the merchant to reconcile the transaction against their order management system or settlement dashboard. In cases where the outcome is DECLINED, the response may include the original issuer decline code, the expected decline reason as predicted by the Risk Model Ensemble, and a flag indicating whether further reattempts are advised.

If the result is ACTION_REQUIRED, the outcome message may contain a remediation link or interaction token directing the merchant—or the customer via merchant infrastructure—to the appropriate customer interaction flow (as initiated in step 935). This enables the merchant to embed call-to-action elements in their user interface or trigger follow-up notifications to the customer. In some configurations, the system may defer the issuance of an outcome response until the remediation window expires or until the customer has completed the requested interaction.

To support operational transparency, each outcome response may be tagged with a processing trace ID linking to a full audit log, including model versions, enrichment source latencies, routing decisions, and interaction histories. Merchants may use this trace data to troubleshoot discrepancies, explain system behavior to customers, or submit escalation requests for manual review.

The Outcome Interface supports schema versioning and content negotiation, allowing merchants to opt into expanded metadata fields or backward-compatible payload formats. The system may also support webhook delivery retries with exponential backoff, dead-letter queue routing for persistent failures, and merchant-side acknowledgment receipts to confirm delivery. All delivery attempts, responses, and merchant acknowledgment records are logged and made accessible via reporting dashboards or export APIs.

Step 940 thus serves as the completion point of the automated recovery workflow, enabling the merchant to take downstream action based on a fully qualified, model-supported, and auditable decision outcome.

At step 945, the system records the full set of transaction inputs, intermediate artifacts, and final outcomes associated with the attempted recovery and appends this data to one or more feedback queues used to support model retraining, system tuning, and ongoing performance optimization. This feedback loop enables the machine learning models and routing logic deployed in step 920 to evolve over time, adapt to new fraud patterns, reflect changes in issuer behavior, and incorporate updated merchant preferences or processing rules.

The feedback data structure may include the original enriched feature vector submitted to the Risk Model Ensemble, the predicted success probability and cost-of-risk outputs, the final routing decision (if any), the actual transaction result as received from the acquiring bank or issuer, and any supplemental metadata such as customer interaction outcomes or failure diagnostics. This dataset is normalized and written to the Analytics & Logging Store 880, and may also be published to a streaming ingestion pipeline for downstream batch or online learning workflows.

In some embodiments, labeled outcome records are inserted into a model training data lake where they are used to periodically retrain classification and regression models under controlled experimental conditions. Model retraining may be scheduled on a fixed cadence (e.g., weekly), triggered based on data drift detection metrics, or invoked manually following significant shifts in success rate, approval ratio, or fraud prevalence. Model updates are validated using holdout evaluation sets and A/B tested prior to promotion into the live inference environment.

Reinforcement learning components used in step 920 may consume this feedback in near-real-time. The observed success or failure of a reprocessing path is used to update reward functions and policy networks governing execution path selection. The system may incorporate online bandit algorithms or deep Q-networks to adaptively adjust exploration-exploitation balance, especially in cases where routing decisions involve uncertain or adversarial environments (e.g., issuer outages, regional instability, acquirer performance variance).

In addition to learning-oriented tasks, the feedback data supports operational monitoring and alerting. Aggregated feedback can be used to compute precision/recall metrics, false positive/negative rates, per-feature contribution analyses, and merchant-specific performance KPIs. These statistics are surfaced through reporting dashboards and analytics exports, and may be used to tune model thresholds, update enrichment source prioritization, or refine eligibility rules applied in earlier stages of the workflow.

Importantly, the feedback process may also serve compliance and audit purposes. By persisting model input/output pairs and associated decision artifacts, the system enables traceability, explainability, and accountability in automated decision-making. For regulated merchants or high-risk use cases, these records may be exported to designated audit environments, redacted or tokenized according to policy, and retained for a prescribed duration to support regulatory inquiries or customer disputes.

Thus, step 945 closes the loop on the intelligent transaction recovery lifecycle, enabling the system to adapt, improve, and learn from every interaction while ensuring compliance, transparency, and continuous performance optimization.

In various embodiments described herein, the disclosed systems and methods provide concrete technological improvements over conventional electronic payment processing and transaction recovery architectures. These improvements are realized through the novel integration of dynamic data enrichment, machine learning-based decisioning, adaptive execution routing, and reprocessing via a legally distinct merchant-of-record, all coordinated within a unified and automated orchestration framework.

First, the system provides a substantial improvement in the reliability and accuracy of failed transaction recovery by replacing static, rule-based retry logic with a machine learning ensemble trained on enriched, multidimensional transaction data. In contrast to traditional systems that reattempt authorization using the same merchant credentials and payment path—often resulting in redundant declines—the disclosed system evaluates probabilistic success likelihood and cost-of-risk using real-time behavioral, contextual, and device-derived signals. This enables the system to selectively reprocess only those transactions with a meaningful predicted outcome, thereby reducing unnecessary load on payment processors and increasing recovery rates.

Second, the system introduces a novel enrichment pipeline that gathers and synthesizes supplemental information from multiple disparate sources, including internal telemetry (e.g., device fingerprints, session metadata) and external intelligence providers (e.g., fraud scores, BIN databases, bureau checks). This transformation of sparse merchant-supplied payloads into dense, normalized feature vectors significantly enhances the input quality for predictive models and results in improved performance metrics such as model calibration, AUC, and approval rate lift. The enrichment process is technically distinct from mere data aggregation, as it involves fingerprinting, behavioral scoring, temporal correlation, and derived feature generation that would not be available to conventional systems lacking such infrastructure.

Third, the system materially improves upon legacy retry systems by enabling execution of the reauthorization request through a new merchant-of-record. This architectural separation not only permits routing through alternate acquirers, descriptor profiles, and MCCs—thus overcoming issuer velocity filters and merchant-specific suppression heuristics—but also transfers settlement risk and compliance burdens to a specialized processing entity. This decoupling provides real, tangible benefits at the system level, including reduction in false fraud declines, improved interchange optimization, and modular contract structures that are not possible with monolithic merchant retry models.

Fourth, the disclosed system introduces a decisioning framework that supports real-time customer interaction as a dynamic input into the recovery flow. By enabling just-in-time collection of missing or corrective payment details (e.g., CVV, address) through embedded or hosted UX modules, the system overcomes data quality limitations that typically prevent successful reattempts. This capability is particularly beneficial in asynchronous contexts, such as subscription billing or token refresh flows, where conventional systems are incapable of engaging the cardholder in a secure and coordinated fashion.

Additionally, the system provides measurable enhancements to transparency, traceability, and explainability through its logging, attribution, and feedback architecture. Each transaction is processed through a deterministic, auditable pipeline in which model inputs, enrichment sources, decision thresholds, and outcome paths are captured and stored. This design enables post hoc analysis, merchant reporting, regulatory auditing, and continuous model retraining using labeled ground truth outcomes-functions that are either impractical or entirely unavailable in legacy systems.

From a technological perspective, the disclosed embodiments do not merely automate a manual business process or implement conventional financial functions on a generic computer. Rather, they fundamentally improve the way failed transactions are evaluated, enriched, and recovered using a combination of machine learning, dynamic routing, and system-level isolation. These improvements are rooted in specific technical solutions to problems unique to distributed transaction processing systems, including latency constraints, duplicate authorization suppression, signal sparsity, fraud prediction, and acquirer heterogeneity.

Accordingly, the present invention provides a specific and substantial improvement in computer functionality and payment network performance, resulting in enhanced reliability, adaptability, and efficiency in the processing of failed electronic payment transactions.

Those skilled in the art will appreciate that computing system 700 is merely illustrative and is not intended to limit the scope of the techniques described herein. Computing system 700 may include any combination of devices or software that may perform or otherwise provide for the performance of the techniques described herein. For example, computing system 700 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 700 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 700 may be transmitted to computing system 700 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include,” “including,” and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square,” “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish, or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

Example embodiments include:
1. A method for purchasing (typically under a factoring model but other models are still possible), on a selected basis, declined payment transactions. In some embodiments, the invention may include receiving, by a merchant or a third party (requestor), a request to evaluate a failed payment transaction with the detailed information related to the failed payment transaction; validate the failed payment transaction received via API; enrich the data received for the failed transaction with external and internal data; define, via algorithms, the expected cause of payment failure; define, via algorithms the probability of successfully process in the following days the transactions successfully, calculating the associated cost of risk; interact in real-time with the customer where needed; notify the party invoking the service of the purchase or not of the declined payment transaction, and if applicable its related cost.
2. The method as in embodiment 1, wherein the request is sent to the eligibility API, and where the response related to the purchase confirmation is made available via the outcome API and/or webhook.
3. The method as in embodiment 1, wherein the data related to the request is enriched with the data collected by the SenseJS JavaScript.
4. The method as in embodiment 1 and claim 7 wherein, where necessary, an interactive session is activated to interact with the customer to request the customer to provide some information or perform some actions.
5. The method as in embodiment 2, wherein the transactional data is enriched with additional internal and external data.
6. The method as in embodiment 3, comprising the ability to perform new authorization(s) on the failed payment transaction, collect the response data, and compare it to the original reason for the decline, enriching further the data available on the transaction.
7. The method as in embodiment 3 and a partial example in claim 5, wherein sophisticated logic and algorithms are deployed to assess the expected cause of payment failure and the probability of successfully processing in the following days the transactions successfully, calculating the associated cost of risk.
8. The method as in embodiment 4, wherein a custom-built interface allows unprecedented flexibility and speed for the definition and implementation of the logic required to assess the expected cause of payment failure and the probability of successfully processing in the following days the transactions successfully, calculating the associated cost of risk.

What is claimed is:

1. A computer-implemented method for reestablishing a declined payment transaction for successful processing, the method comprising:
receiving, by a processor, via an application programming interface (API), transaction data associated with a payment attempt declined during processing by an original merchant, the transaction data comprising payment credentials, customer identity information, and transaction metadata;
validating, by the processor, the received data, wherein validating comprises authenticating a requestor associated with the original merchant and verifying compliance with at least one of processing thresholds or security requirements;
enriching, by the processor, the transaction data with supplemental contextual and behavioral data from one or more sources comprising one or more of internal databases, third-party data providers, device fingerprinting systems, or embedded client-side activity scripts;
analyzing, by the processor, the enriched data using one or more machine learning models configured to evaluate, in real time or near real time, multiple candidate transaction execution paths, the analysis comprising:
identifying a probable cause for the original payment decline;
predicting a likelihood of successful reprocessing through each of a plurality of execution paths;
selecting a candidate execution path having a success likelihood above a defined threshold; and
computing a risk score or cost metric associated with executing the transaction along the selected path;
instantiating, based on the analysis, a new transaction under control of a server entity acting as a new merchant of record, wherein the server entity assumes liability and processing responsibility for the reestablished transaction; and
transmitting, to the original merchant a transaction outcome message indicating whether the failed payment transaction has been successfully reestablished, declined, or requires further action.

2. The method of claim 1, further comprising initiating a real-time or near real-time interactive session with a customer device to collect supplemental information or perform authentication actions.

3. The method of claim 1, wherein the candidate execution paths evaluated by the machine learning model comprise multiple acquiring banks, payment processors, or payment credential variations.

4. The method of claim 1, wherein the machine learning models comprise at least one of: a classification model for outcome prediction, a regression model for risk scoring, or a reinforcement learning model for dynamic routing optimization.

5. The method of claim 1, wherein the enrichment data includes output from a JavaScript library embedded in the original merchant's website, configured to collect one or more of customer device information, behavioral signals, or session context data.

6. The method of claim 2, wherein the interactive session comprises requesting corrected or missing payment information.

7. The method of claim 1, wherein a fingerprinting module generates hashed combinations of customer and transaction data for cross-referencing with historical system-wide behavioral and fraud records.

8. The method of claim 1, wherein a successful reestablishment of the transaction results in a new authorization request initiated by the new merchant of record using the selected transaction path.

9. The method of claim 1, wherein the original merchant does not directly interface with the payment processor once the transaction has been reassigned to the new merchant of record.

10. A system for reestablishing a declined payment transaction for successful processing, comprising:
a computer having a processor and a memory; and
one or more code sets stored in the memory and executed by the processor,
which, when executed, configure the processor to:
receive, via an application programming interface (API), transaction data associated with a payment attempt declined during processing by an original merchant, the transaction data comprising payment credentials, customer identity information, and transaction metadata;
validate the received data, wherein validating comprises authenticating a requestor associated with the original merchant and verifying compliance with at least one of processing thresholds or security requirements;
enrich the transaction data with supplemental contextual and behavioral data from one or more sources comprising one or more of internal databases, third-party data providers, device fingerprinting systems, or embedded client-side activity scripts;
analyze the enriched data using one or more machine learning models configured to evaluate, in real time or near real time, multiple candidate transaction execution paths, the analysis comprising:
identifying a probable cause for the original payment decline;
predicting a likelihood of successful reprocessing through each of a plurality of execution paths;
selecting a candidate execution path having a success likelihood above a defined threshold; and
computing a risk score or cost metric associated with executing the transaction along the selected path;
instantiate, based on the analysis, a new transaction under control of a server entity acting as a new merchant of record, wherein the server entity assumes liability and processing responsibility for the reestablished transaction; and
transmit to the original merchant a transaction outcome message indicating whether the failed payment transaction has been successfully reestablished, declined, or requires further action.

11. The system of claim 10, further configured to initiate a real-time or near real-time interactive session with a customer device to collect supplemental information or perform authentication actions.

12. The system of claim 10, wherein the candidate execution paths evaluated by the machine learning model comprise multiple acquiring banks, payment processors, or payment credential variations.

13. The system of claim 10, wherein the machine learning models comprise at least one of: a classification model for outcome prediction, a regression model for risk scoring, or a reinforcement learning model for dynamic routing optimization.

14. The system of claim 10, wherein the enrichment data includes output from a JavaScript library embedded in the original merchant's website, configured to collect one or more of customer device information, behavioral signals, or session context data.

15. The system of claim 11, wherein the interactive session comprises requesting corrected or missing payment information.

16. The system of claim 10, wherein a fingerprinting module generates hashed combinations of customer and transaction data for cross-referencing with historical system-wide behavioral and fraud records.

17. The system of claim 10, wherein a successful reestablishment of the transaction results in a new authorization request initiated by the new merchant of record using the selected transaction path.

18. The system of claim 10, wherein the original merchant does not directly interface with the payment processor once the transaction has been reassigned to the new merchant of record.

19. A non-transitory computer-readable medium storing computer-program instructions that, when executed by one or more processors, cause the one or more processors to effectuate operations comprising:
Receiving, via an application programming interface (API), transaction data associated with a payment attempt declined during processing by an original merchant, the transaction data comprising payment credentials, customer identity information, and transaction metadata;
Validating, the received data, wherein validating comprising authenticating a requestor associated with the original merchant and verifying compliance with at least one of processing thresholds or security requirements;
enriching, the transaction data with supplemental contextual and behavioral data from one or more sources comprising one or more of internal databases, third-party data providers, device fingerprinting systems, or embedded client-side activity scripts;
analyzing the enriched data using one or more machine learning models configured to evaluate, in real time or near real time, multiple candidate transaction execution paths, the analysis comprising:
identifying a probable cause for the original payment decline;
predicting a likelihood of successful reprocessing through each of a plurality of execution paths;
selecting a candidate execution path having a success likelihood above a defined threshold; and
computing a risk score or cost metric associated with executing the transaction along the selected path;
instantiating, based on the analysis, a new transaction under control of a server entity acting as a new merchant of record, wherein the server entity assumes liability and processing responsibility for the reestablished transaction; and
transmitting, to the original merchant a transaction outcome message indicating whether the failed payment transaction has been successfully reestablished, declined, or requires further action.

20. The non-transitory computer-readable medium of claim 19, wherein the machine learning models comprise at least one of: a classification model for outcome prediction, a regression model for risk scoring, or a reinforcement learning model for dynamic routing optimization.
